(19) United States
(12) Patent Application Publication
(10) Pub. No.: US 2025/0282907 A1
(43) Pub. Date: Sep. 11, 2025

(54) WATER-SOLUBLE POLYURETHANES AS SUPPORT MATERIAL AND SACRIFICIAL MATERIAL FOR 3D PRINTING

(71) Applicant: IVIVA Medical, Inc., Medford, MA (US)

(72) Inventor: Cancan Xu, Oak Creek, WI (US)

(21) Appl. No.: 18/861,135

(22) PCT Filed: Apr. 28, 2023
(86) PCT No.: PCT/US2023/020495

§ 371 Date: Oct. 28, 2024

Related U.S. Application Data
(60) Provisional application No. 63/336,128, filed on Apr. 28, 2022.
(60) Provisional application No. 63/402,700, filed on Aug. 31, 2022.

(51) Int. Cl. C08G 18/48; B29C 64/106; B29C 64/40; B29K 75/00; B33Y 70/00; C08G 18/08; C08G 18/12; C08G 18/24; C08G 18/32; C08G 18/66

(52) U.S. Cl. CPC C08G 18/4833; B29C 64/106; B29C 64/40; B33Y 70/00; C08G 18/0852; C08G 18/12; C08G 18/244; C08G 18/3206; C08G 18/6674; B29K 2075/00; B29K 2995/0062

(57) ABSTRACT

Described herein are water-soluble, non-toxic, thermoplastic polyurethane compositions comprising reaction products of one or more aliphatic diisocyanate compounds, one or more higher molecular weight polyalkylene oxide compounds having a molecular weight of 600-150,000 g/mol and one or more low molecular weight diol chain extender compounds having a molecular weight of 50-300 g/mol, reacted in molar ratios of 50:49-20:1-30 and having a soft segment content of at least 80% and methods for their synthesis and use.

### RELATED APPLICATIONS

This application claims the benefit of U.S. Provisional Application No. 63/336,128, filed Apr. 28, 2022, and U.S. Provisional Application No. 63/402,700, filed Aug. 31, 2022, the contents of both of which are hereby incorporated by reference in their entirety.

### BACKGROUND OF THE INVENTION

Three-dimensional (3D) printing technologies are used to construct 3D objects from computer-aided design (CAD) models or digital 3D models and have been applied in numerous industries (e.g., architecture, aerospace, pharmaceutics, and biomedicine), and their applications are still expanding. Support materials are often needed when printing complex geometries, overhangs, and undercuts in many 3D printing technologies, such as fused deposition modeling (FDM), stereolithography (SLA), digital light processing (DLP), and material jetting. The most traditional way to implement a support is to print the same material that is used in the printed object but in a lower density format, so that the supports can be removed easily post-printing by mechanical means. However, this approach is usually time-consuming, messy, and difficult to remove all the support material completely without damaging the prints, especially from small and intricate features. To make the removal of support material easier, an alternative method in U.S. Pat. No. 5,503,785 describes depositing a thin layer of a mold release material between the support and printed structures. The release materials are usually hydrocarbon wax or water-soluble wax (polyethylene oxide and glycol-based polymers, polyvinyl pyrrolidone-based polymers, maleic acid-based polymer, etc.) or conventional mold release materials (fluorochemicals, silicones paraffins, etc.). Depending on the type of the release material, it can leave an undesirable oily residue on the printed structure. Moreover, it may also make the 3D printing process more complicated.

Solvent-dissolvable support materials provide a good solution to reduce or eliminate tedious work and undesirable residue, as they can be cleared off by solvents while retaining integrity of the build objects. However, most require harsh conditions (e.g., organic solvent, acid, alkali, and high temperature) to be cleared, such as high impact polystyrene (HIPS) (limonene), polylactide (PLA) (sodium hydroxide), VXL® (Xioneer Systems, Austria; VXL® EX washing powder, alkaline), Stratasys™ SR in U.S. Pat. No. 6,790,403 (StrataSys, Ltd, US; alkaline solutions (pH between 11-13), ≥70° C.), and PolyDissolve™ S (Polymaker, China; alkaline solution, above 70° C.). These harsh dissolving conditions are unsafe/dangerous and restrict the selection scope of the co-printing materials (limited to those unsusceptible to the dissolving conditions); more importantly, they render those support materials unsuitable for cell-involved biomedical use.

Aside from use as a support material, dissolvable 3D printed material can be used as sacrificial material to create void spaces in a 3D material or construct after its removal (U.S. Patent No. US20180030409A1). To be useful in high resolution applications such as tissue engineering, the sacrificial material must be soluble in non-toxic solvents (ideally water soluble) to enable its use in conjunction with cells and biomaterials. Furthermore, an ideal sacrificial material should undergo minimal swelling to prevent disruption of surrounding materials or architecture, for example when small vascular structures are to be created next to thin basement membranes or close to other channel networks to enable diffusion across short distances.

There are very limited commercial options for water-soluble materials for use in 3D printing which can dissolve under mild conditions (e.g., comparable to physiological conditions compatible with maintaining living cells, generally temperature 4° C. to 40° C., pH 6.5 to 10.5). Three representative commercial options include Polyvinyl alcohol (PVA), NICHIGO G-POLYMER™ (butenediol vinyl alcohol (BvOH), Nippon Gohsei of Japan) and AQUASYS® (Infinite Material Solutions, LLC, Wisconsin, US). Among them, AQUASYS® 120 (U.S. Pat. No. 10,435,576) was proven to be the fastest material in water dissolution among the other two. However, in practical use, AQUASYS® 120 can take hours, days or even weeks to reach a full dissolution, depending on its size and the dissolution conditions. During its long-term dissolution, the material usually encounters severe swelling before dissolving which will cause the loss of structural fidelity or even collapse when the surrounding build materials are not strong enough to resist the swelling of the support material. According, there continues to be a need for additional agents which can serve as support or sacrificial material.

### SUMMARY OF THE INVENTION

In the present disclosure, a series of novel water-soluble polyurethanes which can quickly dissolve in water at room temperature or 37° C. under neutral pH without obvious swelling are disclosed. These water-soluble polyurethanes have many uses, including their use as support materials in 3D printing processes as well as use as sacrificial material to create void spaces in 3D printed material.

Described herein are thermoplastic polyurethanes which are dissolved at room temperature or 37° C. in water having an approximately neutral pH, have a melting temperature of 50-240° C., and are non-cytotoxic to human kidney fibroblasts. Also described herein are methods of synthesizing these water-soluble, non-toxic, thermoplastic polyurethane polymers, as well as their various uses, including use as a sacrificial substrate for forming interior volumes in basement membrane constructs and microfluidic devices.

Some aspects of the present disclosure are directed to a method of synthesizing a water-soluble, non-toxic, thermoplastic polyurethane polymer comprising the steps of: i) providing one or more aliphatic diisocyanate compounds; ii) providing one or more higher molecular weight polyalkylene oxide compounds having a molecular weight of approximately 600-150,000 g/mol; iii) providing one or more low molecular weight aliphatic diol chain extender compounds having a molecular weight of approximately 50-300 g/mol; iv) mixing, sequentially or simultaneously, in molar ratios of 50:49-20:1-30, the one or more aliphatic diisocyanate compounds, the one or more polyalkylene oxide compounds and the one or more low molecular weight aliphatic diol chain extender compounds; wherein the ratio of isocyanate groups provided by the aliphatic diisocyanate compounds to reactive hydroxyl groups provided by the combination of the polyalkylene oxide compounds and diol chain extender compounds is approximately 1:1; and v) applying one or more conditions sufficient to polymerize the one or more aliphatic diisocyanate compounds, the one or more high molecular weight polyalkylene oxide compounds and the one or more low molecular weight aliphatic diol chain extender compounds, either sequentially or simultaneously, thereby synthesizing a water-soluble, non-toxic, thermoplastic polyurethane polymer.

In some embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, dicyclohexylmethane diisocyanate, bisisocyanatocyclohexylmethane, 2,2,4-trimethylhexamethylene diisocyanate, disisocyanatomethylcyclohexane, norbornane diisocyanate, diisocyanatododecane or combinations thereof. In some embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, diisocyanatododecane or mixtures thereof. In a particularly preferred embodiment, the one or more aliphatic diisocyanate compounds comprise hexamethylene diisocyanate.

In some embodiments, the one or more low molecular weight aliphatic diol chain extender compounds has a molecular weight of approximately 60-200 g/mol. In another embodiment, the one or more low molecular weight aliphatic diol chain extender compounds has a molecular weight of approximately 60-150 g/mol. In still further embodiments, the one or more low molecular weight aliphatic diol chain extender compounds has a molecular weight of approximately 80-125 g/mol.

In some embodiments, the one or more low molecular weight aliphatic diol chain extender compounds are selected from the group consisting of ethylene glycol, diethylene glycol, triethylene glycol, 1,2-propylene glycol, 1,3-propane diol, 1,4-butane diol, 1,6-hexane diol, 1,7-heptane diol, 1,8-octane diol, 1,9-nonane diol, 1,10-decane diol, neopentyl glycol, dipropylene glycol, tripropylene glycol and combinations thereof. In some embodiments, the one or more low molecular weight aliphatic diol chain extender compounds are selected from the group consisting of ethylene glycol, 1,3-propane diol, 1,4-butane diol, 1,5-pentane diol, 1,6-hexane diol, 1,7-heptane diol, 1,8-octane diol, 1,9-nonane diol, 1,10-decane diol and combinations thereof. In some embodiments, the one or more low molecular weight aliphatic diol chain extender compounds are selected from the group consisting of 1,4-butane diol, 1,6-hexane diol, 1,8-octane diol, 1,10-decane diol and combinations thereof. In still other embodiments, the one or more low molecular weight aliphatic diol chain extender compounds comprise 1,4-butane diol.

In some embodiments, the one or more polyalkylene oxide compounds comprise a polyethylene oxide, polypropylene oxide, or polybutylene oxide.

In some embodiments, the one or more polyalkylene oxide compounds comprise a molecular weight of 8,000-100,000 g/mol. In some other embodiments, the one or more polyalkylene oxide compounds comprise a molecular weight of 10,000-80,000 g/mol. In other embodiments, the one or more polyalkylene oxide polymer compounds comprise a molecular weight of 12,000-50,000 g/mol. In still other preferred embodiments, the one or more polyalkylene oxide polymer compounds comprise a molecular weight of 15,000-30,000 g/mol. In a particularly preferred embodiment, the one or more polyalkylene oxide polymer compounds comprise a molecular weight of approximately 20,000 g/mol.

In some particularly preferred embodiments, the one or more aliphatic diisocyanates comprise butylene diisocyanate, pentylene diisocyanate, and/or hexamethylene diisocyanate, the one or more polyalkylene oxide polymer compounds comprise polyethylene oxide or polypropylene oxide polymers with a molecular weight of 15,000-30,000 g/mol and the one or more low molecular weight aliphatic diol chain extender compounds comprise 1,3-propane diol, 1,4-butane diol, 1,5-pentane diol or 1,6-hexane diol.

In other preferred embodiments, the one or more aliphatic diisocynates comprise hexamethylene diisocyanate, the polyalkylene oxide polymer comprises polyethylene oxide having a molecular weight of approximately 20,000 g/mol and the one or more low molecular weight aliphatic diol chain extender compounds comprise 1,4-butane diol.

In some embodiments, step iv) comprises simultaneous mixing of all of the one or more aliphatic diisocyanate compounds, the one or more polyalkylene oxide compounds and the one or more low molecular weight aliphatic diol chain extender compounds to provide a first mixture.

In some embodiments, applying one or more conditions sufficient to polymerize in step v) comprises exposing the first mixture to one or more conditions selected from the group consisting of heat, a duration of time, a catalyst or combinations thereof, thereby obtaining the water-soluble, non-toxic, thermoplastic polyurethane polymer.

In some embodiments, the applying one or more conditions sufficient to polymerize in step v) comprises exposing the first mixture to heat >100° C., in the absence of a catalyst, thereby synthesizing the water-soluble, thermoplastic polyurethane polymer. In some embodiments, the applying one or more conditions sufficient to polymerize in step v) comprises exposing the first mixture to heat <100° C., in the presence of a catalyst, thereby synthesizing the water-soluble, thermoplastic polyurethane polymer, while minimizing both formation of allophanate groups and cross-linking of the polyurethane polymer. In some embodiments, exposing the first mixture to heat <100° C. comprises exposing the first mixture to a temperature of 40° C. to 90° C. In some other embodiments, exposing the first mixture to heat <100° C. comprises exposing the first mixture to a temperature of approximately 70° C.

In some embodiments, the catalyst is selected from the group consisting of stannous octoate, dibutyltin dilaurate, dibutyltin diacetate, dioctyltin dilaurate, 1,4-diazabicyclo[2.2.2]octane, 2-azabicyclo[2.2.1]heptanes, 2-azanorbornanes, 1,8-Diazabicyclo[5.4.0]undec-7-ene, 1,5,7-Triazabicyclo[4,4,0]dec-5-ene, bis(2-dimethylaminoethyl)ether, N-ethylmorpholine, N-methylmorpholine, N,N′-Dimethylethanolamine, N,N-Dimethylcyclohexylamine, Trimethylamineoethylethanolamine, N,N,N′,N′,N″-Pentamethyldiethylenetriamine, Dimethylaminopropylamine, N,N-Dimethylaminoethylmorpholine, 2-Methyl-2-azanorbornane, 3-hydroxy-1-azabicyclo[2.2.2]octane, tetramethylenediamine, dimethylpiperazineN-heterocyclic carbenes, potassium octoate, potassium acetate, lithium octoate, Bismuth octoate, bismuth neodecanoate, zinc octoate, zinc neodecanoate, zirconium octoate, cobalt octoate, nickel octoate, potassium octoate, calcium octoate, antimony octoate, lanthanum octoate, zirconium acetylacetonate, titanium acetylacetoacetate, aluminum acetylacetoacetate methane sulfonic acid, triflic acid and diphenyl phosphate.

In some embodiments, the synthesis is carried out batch-wise or continuously. In some embodiments, the synthesis is carried out in a reactive extruder, or a continuous mixing or spinning device.

In some embodiments, step iv) comprises sequential mixing, and wherein the one or more aliphatic diisocyanate compounds and the one or more high molecular weight polyalkylene oxide compounds are mixed to form a pre-mixture. In some embodiments, the pre-mixture comprising the one or more aliphatic diisocyanate compounds and the one or more high molecular weight polyalkylene oxide compounds further comprise one or more solvents to facilitate homogenous mixing and distribution of both diisocyanate and high molecular weight polyalkylene oxide compounds throughout the pre-mixture. In still further embodiments, the solvent comprises dimethyl sulfoxide (DMSO), N,N-dimethylformamide, tetrahydrofuran (THF) or N,N-dimethylacetamide.

In some embodiments, the applying one or more conditions sufficient to polymerize in step v) comprises exposing the pre-mixture to one or more conditions selected from the group consisting of heat, a duration of time, a catalyst or combinations thereof, thereby obtaining a urethane prepolymer. In some embodiments, the applying one or more conditions sufficient to polymerize in step v) comprises exposing the pre-mixture to heat >100° C., in the absence of a catalyst, thereby synthesizing the urethane prepolymer. In still further embodiments, the applying one or more conditions sufficient to polymerize in step v) comprises exposing the pre-mixture to heat <100° C., in the presence of a catalyst, thereby synthesizing the urethane prepolymer, while minimizing both formation of allophanate groups and cross-linking of the polyurethane polymer. In other embodiments, exposing the first mixture to heat <100° C. comprises exposing the pre-mixture to a temperature of 40° C. to 90° C. In some embodiments, exposing the first mixture to heat <100° C. comprises exposing the pre-mixture to a temperature of approximately 70° C.

In some embodiments, the catalyst is selected from the group consisting of stannous octoate, dibutyltin dilaurate, dibutyltin diacetate, dioctyltin dilaurate, 1,4-diazabicyclo[2.2.2]octane, 2-azabicyclo[2.2.1]heptanes, 2-azanorbornanes, 1,8-Diazabicyclo[5.4.0]undec-7-ene, 1,5,7-Triazabicyclo[4,4,0]dec-5-ene, bis(2-dimethylaminoethyl)ether, N-ethylmorpholine, N-methylmorpholine, N,N′-Dimethylethanolamine, N,N-Dimethylcyclohexylamine, Trimethylamineoethylethanolamine, N,N,N′,N′,N″-Pentamethyldiethylenetriamine, Dimethylaminopropylamine, N,N-Dimethylaminoethylmorpholine, 2-Methyl-2-azanorbornane, 3-hydroxy-1-azabicyclo[2.2.2]octane, tetramethylenediamine, dimethylpiperazineN-heterocyclic carbenes, potassium octoate, potassium acetate, lithium octoate, Bismuth octoate, bismuth neodecanoate, zinc octoate, zinc neodecanoate, zirconium octoate, cobalt octoate, nickel octoate, potassium octoate, calcium octoate, antimony octoate, lanthanum octoate, zirconium acetylacetonate, titanium acetylacetoacetate, aluminum acetylacetoacetate methane sulfonic acid, triflic acid and diphenyl phosphate.

In some embodiments, the sequential mixing comprises providing the one or more aliphatic diisocyanate compounds and the one or more high molecular weight polyalkylene oxide compounds in the form of the urethane prepolymer, and mixing this prepolymer with the one or more low molecular weight diol chain extender compounds to obtain a second mixture. In some embodiments, the method further comprises applying one or more conditions sufficient to form carbamate linkages between the prepolymer and diol chain extender compounds, thereby obtaining the water-soluble, thermoplastic polyurethane.

In some embodiments, the mixing molar ratio range of one or more aliphatic diisocyanate compound, to higher molecular weight polyalkylene oxide compound, to low molecular weight diol chain extender compounds is 50:49-25:1-25. In particularly preferred embodiments, the mixing molar ratio range of one or more aliphatic diisocyanate compound, to higher molecular weight polyalkylene oxide compound, to low molecular weight diol chain extender compounds is 50:49-40:1-10.

In some further embodiments, the method further comprises the step of isolating the polymer through one or more techniques selected from the group consisting of precipitation, dialysis and lyophilization. In some embodiments, the method further comprises the step of removing excess water from one or more of the aliphatic diisocyanate, polyalkylene oxide, diol chain extender, solvent or from the solid surfaces which come into contact therewith by using one or more techniques comprising distillation, drying and/or washing said solid surfaces with a silane liquid.

In some embodiments, the one of more steps of providing, mixing or applying one or more conditions is carried out under an inert gas. In still other embodiments, the melting temperature comprises a first melting temperature corresponding to the melting temperature of the soft segment of the thermoplastic polyurethane polymer or a second melting temperature corresponding to the melting temperature of a hard segment of the thermoplastic polyurethane polymer. In some embodiments, the first melting temperature comprises 50-80° C. and the second melting temperature comprises 100-130° C.

In some embodiments, the polyurethane polymer displays minimal swelling when exposed to water.

Some aspects of the present disclosure are directed to a water-soluble, non-toxic, thermoplastic polyurethane composition comprising a polyurethane made by the process that comprises i) providing one or more aliphatic diisocyanate compounds; ii) providing one or more higher molecular weight polyalkylene oxide compounds having a molecular weight of approximately 600-150,000 g/mol; iii) providing one or more low molecular weight aliphatic diol chain extender compounds having a molecular weight of approximately 50-300 g/mol; iv) mixing, sequentially or simultaneously, in molar ratios of 50:49-20:1-30, the one or more aliphatic diisocyanate compounds, the one or more polyalkylene oxide compounds and the one or more low molecular weight aliphatic diol chain extender compounds; wherein the ratio of isocyanate groups provided by the aliphatic diisocyanate compounds to reactive hydroxyl groups provided by the combination of the polyalkylene oxide compounds and diol chain extender compounds is approximately 1:1; and v) applying one or more conditions sufficient to polymerize the one or more aliphatic diisocyanate compounds, the one or more high molecular weight polyalkylene oxide compounds and the one or more low molecular weight aliphatic diol chain extender compounds, either sequentially or simultaneously, thereby synthesizing a water-soluble, non-toxic, thermoplastic polyurethane polymer, wherein the polyurethane has a melting temperature of 50-240° C., has a soft segment content of at least 80%, is dissolvable at room temperature or 37° C. in water having an approximately neutral pH, is non-cytotoxic to human kidney fibroblasts, and displays minimal swelling when exposed to water.

Some aspects of the present disclosure are directed to a polyurethane polymer composition comprising a water soluble, non-toxic, thermoplastic polyurethane polymer which is the reaction product of at least the following: one or more aliphatic diisocyanate compounds; one or more higher molecular weight polyalkylene oxide compounds having a molecular weight of approximately 600-150,000 g/mole; one or more low molecular weight aliphatic diol chain extender compounds having a molecular weight of approximately 50-300 g/mol; and optionally, a catalyst; wherein the one or more aliphatic diisocyanate compounds, the one or more polyalkylene oxide compounds and the one or more low molecular weight aliphatic diol chain extender compounds are reacted in molar ratios of 50:49-20:1-30, wherein the ratio of isocyanate groups provided by the aliphatic diisocyanate compounds to reactive hydroxyl groups provided by the combination of the polyalkylene oxide compounds and diol chain extender compounds is approximately 1:1; and wherein, the thermoplastic polyurethane has a soft segment content of at least 80%, possesses a melting temperature of approximately 50-240° C., is dissolved at room temperature or 37° C. in water having an approximately neutral pH and is non-cytotoxic to human kidney fibroblasts.

In some embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, dicyclohexylmethane diisocyanate, bisisocyanatocyclohexylmethane, 2,2,4-trimethylhexamethylene diisocyanate, disisocyanatomethylcyclohexane, norbornane diisocyanate, diisocyanatododecane or combinations thereof. In other embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, diisocyanatododecane or mixtures thereof. In a particularly preferred embodiment, the one or more aliphatic diisocyanate compounds comprise hexamethylene diisocyanate.

In some embodiments, the one or more polyalkylene oxide compounds comprise a polyethylene oxide, polypropylene oxide or polybutylene oxide polymer. In some embodiments, the one or more polyalkylene oxide compounds comprise a molecular weight of 8,000-100,000 g/mol. In some embodiments, the one or more polyalkylene oxide compounds comprise a molecular weight of 10,000-80,000 g/mol. In other embodiments, the one or more polyalkylene oxide compounds comprise a molecular weight of 12,000-50,000 g/mol. In some embodiments, the one or more polyalkylene oxide compounds comprise a molecular weight of 15,000-30,000 g/mol. In a particularly preferred embodiment, the one or more polyalkylene oxide compounds comprise a molecular weight of approximately 20,000 g/mol.

In some embodiments, the one or more polyalkylene oxide compounds comprise a molecular weight of approximately 60-200 g/mol. In some embodiments, the one or more low molecular weight aliphatic diol chain extender compounds has a molecular weight of approximately 60-150 g/mol. In some embodiments, the one or more low molecular weight aliphatic diol chain extender compound has a molecular weight of approximately 80-125 g/mol.

In other embodiments, the one or more low molecular weight aliphatic diol chain extender compounds are selected from the group consisting of ethylene glycol, diethylene glycol, triethylene glycol, 1,2-propylene glycol, 1,3-propane diol, 1,4-butane diol, 1,6-hexane diol, 1,7-heptane diol, 1,8-octane diol, 1,9-nonane diol, 1,10-decane diol, neopentyl glycol, dipropylene glycol, tripropylene glycol and combinations thereof. In some embodiments, the one or more low molecular weight aliphatic diol chain extender compounds are selected from the group consisting of ethylene glycol, 1,3-propane diol, 1,4-butane diol, 1, 5-pentane diol, 1,6-hexane diol, 1,7-heptane diol, 1,8-octane diol, 1,9-nonane diol, 1,10-decane diol and combinations thereof. In other embodiments, the one or more low molecular weight aliphatic diol chain extender compounds are selected from the group consisting of 1,4-butane diol, 1,6-hexane diol, 1,8-octane diol, 1,10-decane diol and combinations thereof. In a preferred embodiment, the one or more low molecular weight aliphatic diol chain extender compounds comprise 1,4-butane diol.

In a particularly preferred embodiment, the one or more aliphatic diisocyanates comprise butylene diisocyanate, pentylene diisocyanate, and/or hexamethylene diisocyanate, the one or more polyalkylene oxide polymer compounds comprise polyethylene oxide or polypropylene oxide polymers with a molecular weight of 15,000-30,000 g/mol and the one or more low molecular weight aliphatic diol chain extender compounds comprise 1,3-propane diol, 1,4-butane diol, 1,5-pentane diol or 1,6-hexane diol. In another preferred embodiment, the one or more aliphatic diisocynates comprise hexamethylene diisocyanate, the polyalkylene oxide polymer comprises polyethylene oxide having a molecular weight of approximately 20,000 g/mol and the one or more low molecular weight aliphatic diol chain extender compounds comprise 1,4-butane diol.

In some embodiments, the polyurethane polymer has a soft segment content of greater than 84%. In other embodiments, the polyurethane polymer has a soft segment content of greater than 90%. In still other embodiments, the polyurethane polymer has a soft segment content of greater than 97%. In one preferred embodiment, the polyurethane polymer has a soft segment content of greater than 98%.

In some embodiments, the reaction is a result of mixing simultaneously all of the one or more aliphatic diisocyanate compounds, the one or more polyalkylene oxide compounds, the one or more low molecular weight aliphatic diol chain extender compounds, and optionally, one or more of a catalyst, and solvent(s), to provide a first mixture and then exposing the first mixture to one or more conditions selected from the group consisting of heat, a duration of time, or combinations thereof, thereby obtaining the water-soluble, non-toxic, thermoplastic polyurethane polymer.

In some embodiments, one or more aliphatic diisocyanate compounds, the one or more high molecular weight polyalkylene oxide compounds, and optionally, one or more of a catalyst, and solvent(s), and are mixed to form a pre-mixture and subsequently exposed to one or more conditions selected from the group consisting of heat, a duration of time, or combinations thereof, thereby obtaining a urethane prepolymer, prior to reacting to the one or more low molecular weight diol chain extender compounds to obtain the water-soluble, non-toxic, thermoplastic polyurethane polymer.

In some embodiments, the one or more low molecular weight diol chain extender compounds, and optionally, one or more of a catalyst, and solvent(s), are mixed to obtain a second mixture and subsequently exposed to one or more conditions selected from the group consisting of heat, a duration of time, or combinations thereof, to obtain the water-soluble, non-toxic, thermoplastic polyurethane polymer. In still further embodiments, the first mixture, pre-mixture and/or second mixture is exposed to heat greater than 100° C. in the absence of a catalyst. In some embodiments, the first mixture, pre-mixture and/or second mixture is exposed to heat less than 100° C., in the presence of a catalyst, thereby synthesizing the water-soluble, non-toxic thermoplastic polyurethane polymer or urethane prepolymer.

In some embodiments, the first mixture, pre-mixture and/or second mixture is exposed to a temperature of 40° C. to 90° C. In other embodiments, the first mixture, pre-mixture and/or second mixture is exposed to a temperature of approximately 70° C.

In some embodiments, the catalyst is selected from the group consisting of stannous octoate, dibutyltin dilaurate, dibutyltin diacetate, dioctyltin dilaurate, 1,4-diazabicyclo[2.2.2]octane, 2-azabicyclo[2.2.1]heptanes, 2-azanorbornanes, 1,8-Diazabicyclo[5.4.0]undec-7-ene, 1,5,7-Triazabicyclo[4,4,0]dec-5-ene, bis(2-dimethylaminoethyl)ether, N-ethylmorpholine, N-methylmorpholine, N,N′-Dimethylethanolamine, N,N-Dimethylcyclohexylamine, Trimethylamineoethylethanolamine, N,N,N′,N′,N″-Pentamethyldiethylenetriamine, Dimethylaminopropylamine, N,N-Dimethylaminoethylmorpholine, 2-Methyl-2-azanorbornane, 3-hydroxy-1-azabicyclo[2.2.2]octane, tetramethylenediamine, dimethylpiperazineN-heterocyclic carbenes, potassium octoate, potassium acetate, lithium octoate, Bismuth octoate, bismuth neodecanoate, zinc octoate, zinc neodecanoate, zirconium octoate, cobalt octoate, nickel octoate, potassium octoate, calcium octoate, antimony octoate, lanthanum octoate, zirconium acetylacetonate, titanium acetylacetoacetate, aluminum acetylacetoacetate methane sulfonic acid, triflic acid and diphenyl phosphate.

In other embodiments, the solvent comprises dimethyl sulfoxide (DMSO), N,N-dimethylformamide, N,N-dimethylacetamide, or tetrahydrofuran (THF). In some embodiments, the molar ratio range of the one or more aliphatic diisocyanate compounds, to the higher molecular weight polyalkylene oxide compounds, to the low molecular weight diol chain extender compounds is 50:49-25:1-25. In particularly preferred embodiments, the molar ratio range of the one or more aliphatic diisocyanate compounds, to the higher molecular weight polyalkylene oxide compounds, to the low molecular weight diol chain extender compounds is 50:49-40:1-10.

In some embodiments, the polyurethane polymer demonstrates minimal swelling when exposed to water. In some embodiments, the minimal swelling is determined by comparing wet mass of the polyurethane during water dissolution to the dry mass of the same polyurethane before contact with water, wherein an increase of less than 2.5 times of wet mass over dry mass defines the polyurethane as having minimal swelling during dissolution in water.

In some embodiments, the non-toxicity of the polyurethane polymer is determined by incubating human kidney fibroblasts in cell culture medium containing 0.1 mg/mL of the dissolved thermoplastic polyurethane for 24 hours, wherein the thermoplastic polyurethane polymer is determined to be non-toxic if cellular metabolic activity, as measured by a resazurin fluorescence assay, is not decreased at the end of the 24 hour incubation period.

In some embodiments, the polyurethane polymer composition dissolves readily in water as measured by a 1.75 mm diameter filament formed therefrom substantially dissolving in deionized water at room temperature in approximately 4 hours or less, without agitation. In some embodiments, the polyurethane polymer is linear and is substantially free of crosslinking and/or branching. In other embodiments, the polyurethane polymer is formed from substantially no aromatic isocyanate compounds or isocyanate compounds that have more than 2 isocyanate groups per compound.

In some embodiments, the composition further comprises a water-based solvent in an amount of approximately 30 wt % to 80 wt % by weight of the polyurethane polymer composition. In some embodiments, the composition takes the form of a gel. In some embodiments, the polyurethane polymer is present at approximately 20 wt % to 70 wt % by weight of the polyurethane polymer composition. In some embodiments, the polyurethane polymer makes up greater than 70% and up to and including 100% of the polyurethane polymer composition. In preferred embodiments, the composition consists essentially of or consists of the polyurethane polymer.

Some aspects of the present disclosure are directed to a method of making a basement membrane construct, comprising the steps of (a) printing a sacrificial structure comprising the water soluble, non-toxic thermoplastic polyurethane composition as described herein onto a support structure or a thin layer comprising functional basement membrane material with a three dimensional printer thermoplastic printhead, (b) applying a thin layer comprising functional basement membrane material to the sacrificial structure, thereby obtaining one layer of the construct, (c) optionally repeating steps (a) and then (b) one or more times to obtain one or more additional layers of the construct, (d) optionally embedding or layering the product of steps (a) and (b), and optionally (c) in or with a sacrificial or permanent material, and (e) dissolving the sacrificial material by exposing the sacrificial material to a water-based solvent, to provide one or more interior volumes that retain the original shape and size of the printed sacrificial structure, thereby making a basement membrane construct, wherein the thin layer is porous and has a thickness of 0.25-10 μm.

In some embodiments, step (b) comprises electrospinning a fibrous thin layer membrane directly onto the sacrificial structure, followed by subjection to post-production treatment to impart enhanced mechanical properties to the fibrous thin layer membrane. In some embodiments, step (b) comprises application of pre-formed thin layer comprising functional basement membrane to the sacrificial substrate in combination with compression and either heat or solvent, thereby obtaining a sacrificial substrate wrapped with a thin layer comprising functional basement membrane.

In some embodiments, obtaining the one or more layers in step (c) comprises printing a sacrificial structure comprising water soluble, non-toxic thermoplastic polyurethane composition directly upon the thin layer comprising functional basement membrane material applied to the sacrificial structure in the previous step (b). In some embodiments, obtaining the one or more layers in step (c) comprises printing a sacrificial structure comprising a water soluble, non-toxic thermoplastic polyurethane composition on a support substrate or a thin layer comprising functional basement membrane which is not the thin layer applied in the previous step (b), and prior to the embedding or layering of step (d), further combining the one or more additional layers obtained in step (c) with the layer obtained by initially performing steps (a) and (b).

In some embodiments, the one or more layers of the construct obtained in step (c) and the layer obtained by initially performing steps (a) and (b) are individually or together configured into a desired three dimensional shape before step (d).

In some embodiments, the water soluble, non-toxic thermoplastic polyurethane is heated during printing to 100° C. to 250° C. In some embodiments, wherein both a chamber and a bed temperature are held at 25° C. during the three-dimensional printing process.

In some embodiments, wherein the sacrificial structure is printed in a serpentine or bifurcated pattern. In some embodiments, the product of step (a) and (b), and optionally (c) is embedded into or layered with polydimethylsiloxane, methacrylated gelatin, bulk tissue material or other matrix forming material.

Some aspects of the present disclosure are directed to a method of making a microfluidic device, comprising the steps of: (a) printing a sacrificial structure comprising the water soluble, non-toxic thermoplastic polyurethane composition as described herein on a support structure or a thin layer with a three dimensional printer thermoplastic printhead; (b) embedding or layering the product of step (a), with or without the support structure or thin layer, in or with a sacrificial or permanent material; and (c) optionally repeating steps (a) and then (b) one or more times; and (d) dissolving the sacrificial material by exposing the sacrificial material to a water-based solvent, to provide one or more interior volumes that substantially retain the original shape and size of the printed sacrificial structure, thereby making a microfluidic device.

In some embodiments, the material comprises methacrylated gelatin, polydimethylsiloxane, bulk tissue material or other matrix forming material. In other embodiments, the sacrificial structure comprises an extended longitudinal profile, a substantially elliptical or circular cross-sectional profile and wherein the provided one or more interior volumes comprise channels. In some embodiments, the sacrificial structure is formed into a serpentine or bifurcated pattern with a constant or non-constant diameter.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 depicts an exemplary water-soluble polyurethane (WPU) synthesis scheme. The feeding molar ratios of poly(ethylene glycol) (PEG), 1,6-Hexamethylene diisocyanate (HDI) and 1,4-Butanediol (BDO) were set at 1.5:2:0.5, 1.3:2:0.7, and 1:2:1, which produce water soluble polyurethane polymers named WPU1, WPU2, and WPU3, respectively.

FIG. 2 depicts the Fourier transform infrared (FT-IR) spectra of WPU1, WPU2, and WPU3.

FIG. 3 depicts the water dissolution rates of cylinders formed of AQUASYS® 120, WPU1, WPU2, and WPU3 at 0, 1, 2, 3, 4, and 24 hours. At 24 hours, the cylinders made from WPU1 and WPU2 were completely dissolved. In contrast, at 24 hours the cylinder of AQUASYS®120 had a dry mass remaining of 14±6%, a wet mass remaining of 858±170% and a swelling ratio of 758±170%, while the cylinder of WPU3 had a dry mass remaining of 28±4%, a wet mass remaining of 2010±453%, and a swelling ratio of 1910±453%.

FIGS. 4A-4B depict dissolution properties of polyurethane and AQUASYS® polymer cylinders in water. FIG. 4A depicts a plot of dry mass remaining of WPU1, WPU2, WPU3 and AQUASYS® polymer cylinders over 24 hours in water. FIG. 4B depicts a plot of wet mass remaining of WPU1, WPU2, WPU3 and AQUASYS® polymer cylinders over 24 hours in water.

FIG. 5 depicts a plot of the swelling ratios of WPU1, WPU2, WPU3, and AQUASYS® in water over 24 hours.

FIG. 6 depicts cytotoxicity of WPU1, WPU2, and WPU3 against human kidney fibroblasts at concentrations of 0.01 mg/mL, 0.1 mg/mL and 1 mg/mL as measured by resazurin fluorescence assay.

FIGS. 7A-7E depict the process of embedding the sacrificial substrate WPU1 within a polydimethylsiloxane material and testing for dissolution of WPU1 to provide a microfluidic device with bifurcated channels. FIG. 7A depicts the sacrificial substrate WPU1 arranged on a substrate with a bifurcating pattern. FIG. 7B depicts the sacrificial substrate embedded in polydimethylsiloxane (PDMS). FIG. 7C depicts the results of punching 3 mm holes in the PDMS material near the opposite ends of the WPU1 sacrificial material. FIG. 7D depicts the result of sonicating the microfluidic device in water at room temperature for 3.5 hours. FIG. 7E depicts that the WPU1 sacrificial material was sufficiently cleared such that red dye can be perfused through the channels created by removal of the WPU1 sacrificial material.

FIGS. 8A-8E depict the process of embedding the sacrificial substrate AQUSYS® 120 within a polydimethylsiloxane material and testing for dissolution of AQUSYS® 120 to provide a microfluidic device with bifurcated channels. FIG. 8A depicts the sacrificial substrate AQUASYS® 120 arranged on a substrate with a bifurcating pattern. FIG. 8B depicts the sacrificial substrate embedded in PDMS. FIG. 8C depicts the results of punching 3 mm holes in the PDMS material near the opposite ends of the pattern of the sacrificial material. FIG. 8D depicts the result of sonicating the microfluidic device while submersed in water at room temperature for 3.5 hours. FIG. 8E depicts that red dye is not able to easily be perfused through the PDMS material because the AQUASYS® 120 sacrificial material was not sufficiently cleared during the period of water submersion and sonication.

FIGS. 9A-9E depict a process of producing a microfluidic device with channels in a twisted eight-furcation pattern. FIG. 9A depicts a mold holding a PDMS microfluidic device embedded with a twisted sacrificial substrate WPU2 printed into an eight-furcation pattern. FIG. 9B depicts the PDMS microfluidic device removed from the mold. FIG. 9C depicts the microfluidic device with the sacrificial substrate removed. FIGS. 9D-9E depict different views of the microfluidic device with dye perfused through the channels.

FIGS. 10A-10C depict the formation of a bio-microfluidic device comprising channels having a serpentine pattern with increasing filament spacing. FIG. 10A depicts sacrificial WPU2 printed onto a support surface in a serpentine pattern with increasing filament spacing. FIG. 10B depicts a bio-microfluidic device which has been formed by embedding the WPU2 into a methacrylated gelatin (GelMA) material. FIG. 10C depicts the bio-microfluidic device with red dye perfused through the channel.

FIGS. 11A-11D depict cross-sectional images of a bio-microfluidic device that was manufactured by using GelMA as the bulk hydrogel and WPU2 to create channels. FIGS. 11A-11B depict cross-sectional images of bio-microfluidic device with red dye perfused through the channel. FIG. 11C depicts a table show the cross-sectional area of the WPU substrate compared to the channel cross-sectional area after removal of the WPU. FIG. 11D depicts an enlarged cross-sectional view of the bio-microfluidic device. All cross-sectional images showed that all channels maintained a relatively round shape without channel merge.

FIGS. 12A-12C depict the formation of a bio-microfluidic device comprising channels having a serpentine pattern with increasing filament spacing. FIG. 12A depicts sacrificial AQUASYS® 120 polymer printed onto a support surface in a serpentine pattern with increasing filament spacing. FIG. 12B depicts a bio-microfluidic device which has been formed by embedding the AQUASYS® 120 polymer into a methacrylated gelatin (GelMA) material. FIG. 12C depicts the bio-microfluidic device with red dye attempted be perfused through the channel.

FIGS. 13A-13D depict cross-sectional images of a bio-microfluidic device that was manufactured by using GelMA as the bulk hydrogel and WPU2 to create channels. FIGS. 13A-13B depict cross-sectional images of bio-microfluidic device with red dye perfused through the channel. FIG. 13C depicts a table showing the cross-sectional area of the WPU substrate compared to the channel cross-sectional area after removal of the AQUASYS® 120. FIG. 13D depicts an enlarged cross-sectional view of the bio-microfluidic device which show part of the channels merged together due to the slow water dissolution and high water absorption of the AquaSys® 120. In addition, the channels presented an irregular shape other than a round shape after clearance, and the channel cross-sectional area increased ˜118% compared to that of its original print.

FIGS. 14A-14F depict sequential assembly of a large scale tissue scaffold, using WPU for the sacrificial material. FIG. 14A depicts 3D printing of sacrificial WPU material into a defined channel network. FIG. 14B depicts a fully printed layer, comprising the sacrificial WPU channel network, for integration into a scaffold. FIG. 14C depicts the branched connecting channels added to connect each layer of the scaffold. FIG. 14D depicts a fully assembled scaffold skeleton with sacrificial WPU channel network structure. FIG. 14E depicts a scaffold that comprises the sacrificial WPU channel network skeleton structure embedded in hydrogel bulk material. FIG. 14F depicts a scaffold which has been cut transversely to show the hierarchical channel network left inside the scaffold after removal of the WPU sacrificial material.

FIGS. 15A-15B depict the flexibility of the sacrificial WPU material used to form a channel network within a folded over pancreas scaffold, later seeded with cells. Briefly, sacrificial WPU material is printed on a planar substrate, and thereafter folded into a U shape before being embedded into a gelatin bulk material. The sacrificial material is then dissolved and cells are seeded within the channels thus formed to provide the pancreas scaffold. FIG. 15A depicts a microscopic image showing cell seeded channels on first layer of folded scaffold. FIG. 15B depicts a full pancreas scaffold comprising a folded channel network.

FIGS. 16A-16D depict the sequential assembly of a large scale tissue scaffold, using WPU as sacrificial material. FIG. 16A depicts a membrane with a WPU channel network pattern printed thereon, undergoing close proximity electrospinning for fibrous membrane wrapping. FIG. 16B depicts electrospun fibers comprising polycaprolactone (PCL) and gelatin, accumulating over printed WPU channel network. The location of accumulated electrospun fibers is influenced by the collector electrode position. FIGS. 16C-16D depict Scanning Electron Microscope (SEM) images of the cross-section of the electrospun PCL/gelatin fibrous membrane wrapped over the printed WPU channel network pattern after close proximity electrospinning. Magnification of the images in FIGS. 16C-16D are ×160 and ×120 magnification, respectively.

FIGS. 17A-17B depict the morphological characteristics of a heat treated and compressed fibrous membrane wrapping of printed WPU channel patterns. Briefly, the WPU channel patterns were 3D printed on electrospun membrane comprising PCL and gelatin, placed between two opposing additional membrane layers, and then set between two opposing soft silicone pads while heating to approximately 55° C. for 18 hours. FIG. 17A depicts a SEM image at ×55 magnification of a cross-section of an electrospun fibrous membrane wrapped 3D printed WPU channel pattern, treated with heat and compression. FIG. 17B depicts a SEM image at ×180 magnification of a cross-section of an electrospun fibrous membrane wrapped 3D printed WPU channel pattern, treated with heat and compression.

### DETAILED DESCRIPTION OF THE INVENTION

Described herein are water-soluble, non-toxic, thermoplastic polyurethanes which are dissolved at room temperature or 37° C. in water having an approximately neutral pH, have a melting temperature of 50-240° C., and are non-cytotoxic to human kidney fibroblasts. Also described herein are methods of synthesizing these water-soluble, non-toxic, thermoplastic polyurethane polymers and methods of using the polymers, including use as a sacrificial substrate for forming interior volumes in basement membrane constructs and microfluidic devices.

Some aspects of the present disclosure are directed to a method of synthesizing a water-soluble, non-toxic, thermoplastic polyurethane polymer comprising the steps of: i) providing one or more aliphatic diisocyanate compounds; ii) providing one or more higher molecular weight polyol compounds having a molecular weight of approximately 600-150,000 g/mol; iii) providing one or more low molecular weight aliphatic diol chain extender compounds having a molecular weight of approximately 50-300 g/mol; iv) mixing, sequentially or simultaneously, in molar ratios of 50:49-20:1-30, the one or more aliphatic diisocyanate compounds, the one or more polyalkylene oxide compounds and the one or more low molecular weight aliphatic diol chain extender compounds; wherein the ratio of isocyanate groups provided by the aliphatic diisocyanate compounds to reactive hydroxyl groups provided by the combination of the polyalkylene oxide compounds and diol chain extender compounds is approximately 1:1; and v) applying one or more conditions sufficient to polymerize the one or more aliphatic diisocyanate compounds, the one or more high molecular weight polyalkylene oxide compounds and the one or more low molecular weight aliphatic diol chain extender compounds, either sequentially or simultaneously, thereby synthesizing a water-soluble, non-toxic, thermoplastic polyurethane polymer.

The one or more aliphatic diisocyanate compounds utilized in the formation of the water-soluble, non-toxic, thermoplastic polyurethane are not limited and may be any suitable aliphatic isocyanate compounds with an isocyanate functionality of 2, and capable of forming two carbamate linkages when combined with a higher molecular weight polyol compound having two reactive hydroxyl groups and/or a low molecular weight aliphatic diol chain extender compound, having two reactive hydroxyl groups as described herein. Exemplary diisocyanates which can be used in forming the water-soluble, non-toxic, thermoplastic polyurethane include, but are not limited to, ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, dicyclohexylmethane diisocyanate, bisisocyanatocyclohexylmethane, 2,2,4-trimethylhexamethylene diisocyanate, disisocyanatomethylcyclohexane, norbornane diisocyanate, diisocyanatododecane or combinations thereof. In some embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, diisocyanatododecane or mixtures thereof. In a particularly preferred embodiment, the one or more aliphatic diisocyanate compounds comprise hexamethylene diisocyanate, propylene diisocyanate, butylene diisocyanate, pentylene diisocyanate, and/or heptamethylene diisocyanate. In another particularly preferred embodiment, the one or more aliphatic diisocyanates comprise hexamethylene diisocyanate.

In certain embodiments, the one or more aliphatic diisocyanates comprise a mixture of at least two, at least three, at least four or at least five or more different aliphatic diisocynates. In another embodiment, a binary, tertiary, quaternary, or a quinary mixture of aliphatic diisocyanates is utilized to form the water-soluble, non-toxic, thermoplastic polyurethane. In some embodiments, the mixture of aliphatic diisocyanates comprise hexamethylene diisocyanate in addition to at least one other aliphatic diisocyanate.

The one or more low molecular weight aliphatic diol chain extender compounds is not particularly limited and includes aliphatic compounds that have at least two reactive hydroxyl groups per compound, and which may form two carbamate linkages with one or more aliphatic diisocyanates as described herein. In some embodiments, the one or more low molecular weight aliphatic diol chain extender compounds has a molecular weight of approximately 60-300 g/mol, of approximately 60-200 g/mol, of approximately 60-150 g/mol, or of approximately 80-125 g/mol. In some embodiments, the one or more low molecular weight aliphatic diol chain extender compounds has a molecular weight of approximately 50, 55, 60, 65, 70, 75, 80, 85, 90, 95, 100, 110, 120, 125, 130, 140, 150, 175, 200, 250 or 300 g/mol. In still further embodiments, the one or more low molecular weight aliphatic diol chain extender compounds has a molecular weight of less than 300 g/mol, less than 250 g/mol, less than 225 g/mol, less than 200 g/mol, less than 180 g/mol, less than 170 g/mol, less than 160 g/mol, less than 150 g/mol, less than 140 g/mol, less than 130 g/mol, less than 125 g/mol, less than 120 g/mol, less than 110 g/mol or less than 100 g/mol and has a molecular weight greater than 50 g/mol, greater than 55 g/mol, greater than 60 g/mol, greater than 65 g/mol, or greater than 70 g/mol.

In some embodiments, the one or more low molecular weight aliphatic diol chain extender compounds are selected from the group consisting of ethylene glycol, diethylene glycol, triethylene glycol, 1,2-propylene glycol, 1,3-propane diol, 1,4-butane diol, 1,6-hexane diol, 1,7-heptane diol, 1,8-octane diol, 1,9-nonane diol, 1,10-decane diol, neopentyl glycol, dipropylene glycol, tripropylene glycol and combinations thereof. In some embodiments, the one or more low molecular weight aliphatic diol chain extender compounds are selected from the group consisting of ethylene glycol, 1,3-propane diol, 1,4-butane diol, 1,5-pentane diol, 1,6-hexane diol, 1,7-heptane diol, 1,8-octane diol, 1,9-nonane diol, 1,10-decane diol and combinations thereof. In some embodiments, the one or more low molecular weight aliphatic diol chain extender compounds are selected from the group consisting of 1,4-butane diol, 1,6-hexane diol, 1,8-octane diol, 1,10-decane diol and combinations thereof. In still other embodiments, the one or more low molecular weight aliphatic diol chain extender compounds comprise 1,4-butane diol.

In certain embodiments, the one or more low molecular weight aliphatic diol chain extender compounds comprise a mixture of at least two, at least three, at least four or at least five or more different low molecular weight aliphatic diol chain extender compounds. In another embodiment, a binary, tertiary, or quaternary mixture of low molecular weight aliphatic diol chain extender compounds is utilized to form the water-soluble, non-toxic, thermoplastic polyurethane. In some embodiments, the mixture of low molecular weight aliphatic diol chain extender compounds comprises 1,4-butane diol in addition to at least one other low molecular weight aliphatic diol chain extender compound.

The one or more higher molecular weight polyol compounds is not particularly limited, and include a higher molecular weight polyol compound which contains at least two reactive hydroxyl groups which can form two carbamate linkages when reacted with one or more aliphatic diisocyanate compounds as described herein. In certain embodiments, the higher molecular weight polyol compounds comprise polyether and/or polyester compounds that contain two reactive hydroxyl groups per polymer. A reactive hydroxyl group is a hydroxyl group which is not hindered, sterically or otherwise, from reacting with an isocyanate group. In certain embodiments, the one or more higher molecular weight polyol compounds comprise exactly two reactive hydroxyl groups per polymer. Commonly, these reactive hydroxyl groups will be found on opposite terminal ends of the polymer. In some preferred embodiments, the higher molecular weight polyol compounds have very minimal branching. In still other preferred embodiments, the higher molecular weight polyol compounds are substantially linear. In some embodiments, the higher molecular weight polyol compound is a higher molecular weight polyalkylene oxide. In some preferred embodiments, the one or more polyalkylene oxide compounds comprise a polyethylene oxide, polypropylene oxide, or polybutylene oxide.

In some embodiments, the one or more higher molecular weight polyol compounds are preferably one or more polyalkylene oxide compounds which comprise a molecular weight of 8,000-100,000 g/mol. In some other embodiments, the one or more polyalkylene oxide compounds comprise a molecular weight of 10,000-80,000 g/mol, 12,000-50,000 g/mol, or 15,000-30,000 g/mol. In a particularly preferred embodiment, the one or more polyalkylene oxide polymer compounds comprise a molecular weight of approximately 20,000 g/mol. In some embodiments the one or more polyalkylene oxide compounds comprise a molecular weight of at least 1,000 g/mol, at least 1,500 g/mol, at least 2,000 g/mol, at least 2,500 g/mol, at least 3,000 g/mol, at least 3,500 g/mol, at least 4,000 g/mol, at least 4,500 g/mol, at least 5,000 g/mol, at least 5,500 g/mol, at least 6,000 g/mol, at least 6,500 g/mol, at least 7,000 g/mol, at least 7,500 g/mol, at least 8,000 g/mol, at least 8,500 g/mol, at least 9,000 g/mol, at least 9,500 g/mol, at least 10,000 g/mol, at least 10,500 g/mol, at least 11,000 g/mol, at least 11,500 g/mol, at least 12,000 g/mol, at least 12,500 g/mol, at least 13,000 g/mol, at least 13,500 g/mol, at least 14,000 g/mol, at least 14,500 g/mol, at least 15,000 g/mol, at least 15,500 g/mol, at least 16,000 g/mol, at least 16,500 g/mol, at least 17,000 g/mol, at least 17,500 g/mol, at least 18,000 g/mol, at least 18,500 g/mol, at least 19,000 g/mol, at least 19,500 g/mol, at least 20,000 g/mol, at least 20,5000 g/mol, at least 21,000 g/mol, at least 21,500 g/mol, at least 22,000 g/mol, at least 22,500 g/mol, at least 23,000 g/mol, at least 23,500 g/mol, at least 24,000 g/mol, at least 24,500 g/mol, at least 25,000 g/mol or at least 25,500 g/mol.

In certain embodiments the one or more higher molecular weight polyalkylene oxide compound has a molecular weight of less than 300,000 g/mol, less than 250,000 g/mol, less than 225,000 g/mol, less than 200,000 g/mol, less than 175,000 g/mol, less than 150,000 g/mol, less than 125,000 g/mol, less than 115,000 g/mol, less than 100,000 g/mol, less than 90,000 g/mol, less than 80,000 g/mol, less than 75,000 g/mol, less than 70,000 g/mol, less than 65,000 g/mol, less than 60,000 g/mol, less than 55,000 g/mol, less than 50,000 g/mol, less than 45,000 g/mol, less than 40,000 g/mol, less than 35,000 g/mol, less than 30,000 g/mol, less than 25,000 g/mol, less than 20,000 g/mol, less than 15,000 g/mol, less than 10,000 g/mol, less than 5,000 g/mol or less than 2,500 g/mol. In some embodiments the one or more higher molecular weight polyalkylene oxide compounds has a molecular weight of approximately 1,000 g/mol, approximately 2,000 g/mol, approximately 2,500 g/mol, approximately 5,000 g/mol, approximately 7,500 g/mol, approximately 10,000 g/mol, approximately 12,500 g/mol, approximately 15,000 g/mol, approximately 17,500 g/mol, approximately 20,000 g/mol, approximately 22,500 g/mol, approximately 25,000 g/mol, approximately 30,000 g/mol, approximately 40,000 g/mol, approximately 50,000 g/mol, approximately 60,000, approximately 75,000 g/mol, approximately 100,000 g/mol, approximately 125,000 g/mol, approximately 150,000 g/mol, approximately 175,000 g/mol, approximately 200,000 g/mol, or approximately 250,000 g/mol.

In certain embodiments, the one or more higher molecular weight polyalkylene oxide compounds comprise a mixture of at least two, at least three or at least four or more different higher molecular weight polyalkylene oxide compounds. In another embodiment, a binary, or tertiary mixture of higher molecular weight polyalkylene oxide compounds is utilized to form the water-soluble, non-toxic, thermoplastic polyurethane. In some embodiments, the mixture of higher molecular weight polyalkylene oxide compounds comprise polyethylene oxide with a molecular weight of approximately 5,000 g/mol, approximately 10,000 g/mol, approximately 15,000 g/mol, approximately 20,000 g/mol or approximately 25,000 g/mol in addition to at least one other higher molecular weight polyalkylene oxide compound.

In some particularly preferred embodiments, the one or more aliphatic diisocyanates comprise butylene diisocyanate, pentylene diisocyanate, and/or hexamethylene diisocyanate, the one or more polyalkylene oxide polymer compounds comprise polyethylene oxide or polypropylene oxide polymers with a molecular weight of 15,000-30,000 g/mol and the one or more low molecular weight aliphatic diol chain extender compounds comprise 1,3-propane diol, 1,4-butane diol, 1,5-pentane diol and/or 1,6-hexane diol.

In other preferred embodiments, the one or more aliphatic diisocynates comprise hexamethylene diisocyanate, the polyalkylene oxide polymer comprises polyethylene oxide having a molecular weight of approximately 20,000 g/mol and the one or more low molecular weight aliphatic diol chain extender compounds comprise 1,4-butane diol.

In some embodiments, step iv) comprises simultaneous mixing all of the one or more aliphatic diisocyanate compounds, the one or more polyalkylene oxide compounds and the one or more low molecular weight aliphatic diol chain extender compounds to provide a first mixture. The equipment utilized to simultaneously mix the one or more aliphatic diisocyanate compounds, the one or more polyalkylene oxide compounds and the one or more low molecular weight aliphatic diol chain extender compounds is not particularly limited so long as it achieves simultaneous homogenous mixture of these components. In some embodiments, the devices useful for carrying out the invention include, but are not limited to single-, dual- or triple-shaft mixers, a single or double planetary mixer, a high viscosity or high-speed disperser, a ribbon, paddle, tumble or vertical blender, a kneader extruder, a reactive extruder, or a continuous spinning device.

In some embodiments, applying one or more conditions sufficient to polymerize in step v) comprises exposing the first mixture to heat, a duration of time, a catalyst or combinations thereof, thereby obtaining the water-soluble, non-toxic, thermoplastic polyurethane polymer.

In some embodiments, to facilitate more rapid synthesis of the water-soluble, non-toxic, thermoplastic polyurethane from the first mixture, a catalyst is added to the first mixture. The catalyst included in the first mixture is not limited and may include any compound which catalyzes the formation of a carbamate bond from a hydroxyl containing compound and an isocyanate containing compound. Such catalysts may include metal carboxylates, tertiary amines, organic acids and organic bases. Exemplary catalysts for catalyzing the formation of polyurethane polymer from the first mixture include, but are not limited to, stannous octoate, dibutyltin dilaurate, dibutyltin diacetate, dioctyltin dilaurate, 1,4-diazabicyclo[2.2.2]octane, 2-azabicyclo[2.2.1]heptanes, 2-azanorbornanes, 1,8-Diazabicyclo[5.4.0]undec-7-ene, 1,5,7-Triazabicyclo[4,4,0]dec-5-ene, bis(2-dimethylaminoethyl)ether, N-ethylmorpholine, N-methylmorpholine, N,N′-Dimethylethanolamine, N,N-Dimethylcyclohexylamine, Trimethylamineoethylethanolamine, N,N,N′,N′,N″-Pentamethyldiethylenetriamine, Dimethylaminopropylamine, N,N-Dimethylaminoethylmorpholine, 2-Methyl-2-azanorbornane, 3-hydroxy-1-azabicyclo[2.2.2]octane, tetramethylenediamine, dimethylpiperazineN-heterocyclic carbenes, potassium octoate, potassium acetate, lithium octoate, Bismuth octoate, bismuth neodecanoate, zinc octoate, zinc neodecanoate, zirconium octoate, cobalt octoate, nickel octoate, potassium octoate, calcium octoate, antimony octoate, lanthanum octoate, zirconium acetylacetonate, titanium acetylacetoacetate, aluminum acetylacetoacetate methane sulfonic acid, triflic acid and diphenyl phosphate.

It will generally be understood by a person of ordinary skill in the art that the catalyst is typically not consumed in the process of catalyzing the formation of polyurethane. In such circumstances, the catalyst may be recovered, regenerated as necessary and reused to catalyze the polymerization of further polyurethane polymers. When the process involves synthesis of polyurethane polymer in batches, the recovered catalyst may be added to future batches, in addition to any new catalyst necessary to replace any portion of the old catalyst which was not recovered or regenerated. If the process is a continuous process, the catalyst may be reintroduced upstream of the point where the one or more aliphatic diisocyanate compounds, the one or more polyalkylene oxide compounds and the one or more low molecular weight aliphatic diol chain extender compounds mix, such as by incorporating the catalyst within a stream containing a single component. In other embodiments, the catalyst may be first introduced into a solvent, which in turn is added to one of the components or all of the components at the point of simultaneous mixture of all three components. By recovering and reusing the catalyst, significant cost savings may be achieved.

In some embodiments, at least 20%, at least 30%, at least 40%, at least 50%, at least 60%, at least 70%, at least 80%, at least 90%, at least 95%, at least 98% or more of the catalyst is recovered. In some embodiments, substantially all of the catalyst is recovered. In some embodiments, some of the catalyst is not recovered. In still further embodiments, no effort is made to recover the catalyst.

In some embodiments of the invention, the reaction is allowed to proceed for a predetermined period of time. This predetermined period of time may range from 10 minutes to an entire week or longer. In some embodiments, the period of time is set based upon the degree of heat the first mixture is exposed to and whether or not a catalyst has been added to the first mixture. In some embodiments the first mixture is allowed to react for at least 30 minutes, at least 1 hour, at least 2 hours, at least 3 hours, at least 4 hours, at least 5 hours, at least 6 hours, at least 7 hours, at least 8 hours, at least 9 hours, at least 10 hours, at least 12 hours, at least 24 hours, at least 30 hours, at least 36 hours, at least 42 hours, at least 48 hours, at least 72 hours or at least 96 hours or longer. In particular embodiments, the reaction is carried out in the presence of a catalyst and/or heat, and the reaction is allowed to proceed for less than 72 hours, less than 48 hours, less than 36 hours, less than 24 hours, less than 12 hours, less than 8 hours, less than 6 hours, less than 4 hours or less 2 hours.

In some embodiments, the applying one or more conditions sufficient to polymerize in step v) comprises exposing the first mixture to heat >100° C., in the absence of a catalyst, thereby synthesizing the water-soluble, thermoplastic polyurethane polymer. In some embodiments, the applying one or more conditions sufficient to polymerize in step v) comprises exposing the first mixture to heat <100° C., in the presence of a catalyst, thereby synthesizing the water-soluble, thermoplastic polyurethane polymer, while minimizing both formation of allophanate groups and cross-linking of the polyurethane polymer. In some embodiments, exposing the first mixture to heat <100° C. comprises exposing the first mixture to a temperature of 40° C. to 90° C. In some other embodiments, exposing the first mixture to heat <100° C. comprises exposing the first mixture to a temperature of approximately 70° C.

In some embodiments the first mixture is exposed to heat of at least 28° C., at least 30° C., at least 35° C., at least 40° C., at least 45° C., at least 50° C., at least 55° C., at least 60° C., at least 65° C. at least 70° C., at least 75° C., at least 80° C., at least 85° C., at least 90° C. or at least 95° C. In some embodiments, the first mixture is exposed to heat less than 110° C., less than 105° C., less than 100° C., less than 95° C., less than 90° C., less than 85° C., less than 80° C., or less than 75° C. In certain embodiments, the first mixture is exposed to heat of 70° C., 37° C. or to no heat above room temperature, which for purposes of this application is defined as a temperature between 19° C. to 23° C. In some embodiments, the temperature of the first mixture is kept below 100° C. to minimize formation of allophanate groups and also to minimize cross-linking of the polyurethane polymer. It will be understood that in some embodiments, where the reaction proceeds exothermically, active cooling may be applied to reduce and maintain the temperature of the first mixture below a set temperature point, such as below 100° C., below 90° C., below 80° C., or below 70° C.

In some embodiments, the synthesis is carried out batch-wise or continuously. In some embodiments, the synthesis is carried out in a reactive extruder, or a continuous mixing or spinning device.

In some embodiments, step iv) comprises sequential mixing, and wherein the one or more aliphatic diisocyanate compounds and the one or more high molecular weight polyalkylene oxide compounds are mixed to form a pre-mixture. The equipment utilized to mix the one or more aliphatic diisocyanate compounds and the one or more higher molecular weight polyalkylene oxide compounds to form a premixture is not particularly limited so long as it achieves homogenous mixture of these components. In some embodiments, the devices useful for carrying out the invention may be the same as those that can be used to provide simultaneous mixing of the aliphatic diisocyanate, polyalkylene oxide and chain extender compounds. These devices include, but are not limited to single-, dual- or triple-shaft mixers, a single or double planetary mixer, a high viscosity or high-speed disperser, a ribbon, paddle, tumble or vertical blender, a kneader extruder, a reactive extruder or a continuous spinning device.

In some embodiments, the pre-mixture comprising the one or more aliphatic diisocyanate compounds and the one or more high molecular weight polyalkylene oxide compounds further comprise one or more solvents to facilitate homogenous mixing and distribution of both diisocyanate and high molecular weight polyalkylene oxide compounds throughout the pre-mixture. The solvent or solvents used in dissolving the ingredients of the premixture are not particularly limited, and include those solvents that dissolve one or more aliphatic diisocyanate compounds, one or more higher molecular weight polyalkylene oxide compounds, without hindering the formation of a urethane prepolymer. In some embodiments, the solvent or solvents are selected for being environmentally friendly and less toxic compared to other available solvents and may be compatible with a metallic carboxylate, tertiary amine or other catalyst. Examples of suitable solvents include, but are not limited to, dimethyl sulfoxide (DMSO), N,N-dimethylformamide, tetrahydrofuran (THF) or N,N-dimethylacetamide.

In some embodiments, the applying one or more conditions sufficient to polymerize in step v) comprises exposing the pre-mixture to one or more conditions selected from the group consisting of heat, a duration of time, a catalyst or combinations thereof, thereby obtaining a urethane prepolymer.

In some embodiments, to facilitate more rapid synthesis of the pre-mixture, a catalyst is added to the pre-mixture. The catalyst included in the pre-mixture is not limited and may include any compound which catalyzes the formation of a carbamate bond from a hydroxyl containing compound and an isocyanate containing compound. Such catalysts may include metal carboxylates, tertiary amines, organic acids and organic bases. Exemplary catalysts for catalyzing the formation of a urethane pre-polymer from the pre-mixture include, but are not limited to, stannous octoate, dibutyltin dilaurate, dibutyltin diacetate, dioctyltin dilaurate, 1,4-diazabicyclo[2.2.2]octane, 2-azabicyclo[2.2.1]heptanes, 2-azanorbornanes, 1,8-Diazabicyclo[5.4.0]undec-7-ene, 1,5,7-Triazabicyclo[4,4,0]dec-5-ene, bis(2-dimethylaminoethyl)ether, N-ethylmorpholine, N-methylmorpholine, N,N′-Dimethylethanolamine, N,N-Dimethylcyclohexylamine, Trimethylamineoethylethanolamine, N,N,N′,N′,N″-Pentamethyldiethylenetriamine, Dimethylaminopropylamine, N,N-Dimethylaminoethylmorpholine, 2-Methyl-2-azanorbornane, 3-hydroxy-1-azabicyclo[2.2.2]octane, tetramethylenediamine, dimethylpiperazineN-heterocyclic carbenes, potassium octoate, potassium acetate, lithium octoate, Bismuth octoate, bismuth neodecanoate, zinc octoate, zinc neodecanoate, zirconium octoate, cobalt octoate, nickel octoate, potassium octoate, calcium octoate, antimony octoate, lanthanum octoate, zirconium acetylacetonate, titanium acetylacetoacetate, aluminum acetylacetoacetate methane sulfonic acid, triflic acid and diphenyl phosphate.

In some embodiments, the reaction is allowed to proceed for a predetermined period of time. This predetermined period of time may range from 10 minutes to an entire week or more. In some embodiments, the period of time is set based upon the degree of heat the pre-mixture is exposed to and whether or not a catalyst has been added to the pre-mixture. In some embodiments the pre-mixture is allowed to react for at least 30 minutes, at least 1 hour, at least 2 hours, at least 3 hours, at least 4 hours, at least 5 hours, at least 6 hours, at least 7 hours, at least 8 hours, at least 9 hours, at least 10 hours, at least 12 hours, at least 24 hours, at least 30 hours, at least 36 hours, at least 42 hours, at least 48 hours, at least 72 hours or at least 96 hours. In some particular embodiments, the reaction is carried out in the presence of a catalyst and/or heat, and the reaction is allowed to proceed for less than 72 hours, less than 48 hours, less than 36 hours, less than 24 hours, less than 12 hours, less than 8 hours, less than 6 hours, less than 4 hours or less 2 hours.

In some embodiments, the applying one or more conditions sufficient to polymerize in step v) comprises exposing the pre-mixture to heat >100° C., in the absence of a catalyst, thereby synthesizing the urethane pre-polymer. In still further embodiments, the applying one or more conditions sufficient to polymerize in step v) comprises exposing the pre-mixture to heat <100° C., in the presence of a catalyst, thereby synthesizing the urethane prepolymer, while minimizing both formation of allophanate groups and cross-linking of the polyurethane polymer. In other embodiments, exposing the first mixture to heat <100° C. comprises exposing the pre-mixture to a temperature of 40° C. to 90° C. In some embodiments, exposing the first mixture to heat <100° C. comprises exposing the pre-mixture to a temperature of approximately 70° C.

In some embodiments the pre-mixture is exposed to heat of at least 28° C., at least 30° C., at least 35° C., at least 40° C., at least 45° C., at least 50° C., at least 55° C., at least 60° C., at least 65° C. at least 70° C., at least 75° C., at least 80° C., at least 85° C., at least 90° C. or at least 95° C. In some embodiments, the first mixture is exposed to heat less than 110° C., less than 105° C., less than 100° C., less than 95° C., less than 90° C., less than 85° C., less than 80° C., or less than 75° C. In certain embodiments, the pre-mixture is exposed to heat of 70° C., 37° C. or to no heat above room temperature, which for purposes of this application is defined as a temperature between 19° C. to 23° C. In some embodiments, the temperature of the pre-mixture is kept below 100° C. to minimize formation of allophanate groups and also to minimize cross-linking of the urethane pre-polymer. It will be understood that in some embodiments, where the reaction proceeds exothermically, active cooling may be applied to reduce and maintain the temperature of the pre-mixture below a set temperature point, such as below 100° C., below 90° C. or below 80° C.

In some embodiments, the sequential mixing comprises providing the one or more aliphatic diisocyanate compounds and the one or more high molecular weight polyalkylene oxide compounds in the form of the urethane prepolymer, and mixing this prepolymer with the one or more low molecular weight diol chain extender compounds to obtain a second mixture. This mixing may be carried out in the same device or apparatus in which the premixture was formed, or may be performed in a separate device or apparatus. As discussed previously, single-, dual- or triple-shaft mixers, a single or double planetary mixer, a high viscosity or high-speed disperser, a ribbon, paddle, tumble or vertical blender, a kneader extruder, a reactive extruder or a continuous spinning device, are suitable devices for this purpose. In some embodiments, the method further comprises applying one or more conditions sufficient to form carbamate linkages between the prepolymer and diol chain extender compounds, thereby obtaining the water-soluble, non-toxic, thermoplastic polyurethane. These conditions may include heat, a duration of time and the inclusion of a catalyst.

In some embodiments, the mixing molar ratio range of one or more aliphatic diisocyanate compound, to higher molecular weight polyalkylene oxide compound, to low molecular weight diol chain extender compounds is 50:49-25:1-25. In particularly preferred embodiments, the mixing molar ratio range of one or more aliphatic diisocyanate compound, to higher molecular weight polyalkylene oxide compound, to low molecular weight diol chain extender compounds is 50:49-40:1-10. It will be appreciated that by increasing the ratio of higher molecular weight polyalkylene oxide compound to low molecular weight diol chain extender compound, the percentage of soft segment in the resulting polyurethane polymer formed therewith is increased. Conversely, by decreasing the ratio of higher molecular weight polyalkylene oxide compound to low molecular weight diol chain extender compound, the percentage of hard segment in the resulting polyurethane polymer formed therewith is increased. Thus, properties of the polyurethane, such as water dissolution time, or rigidity of the polymer, may be tuned by varying the ratio of the higher molecular weight polyalkylene oxide compounds to low molecular weight compounds to a fixed amount of aliphatic diisocynates compound.

In further embodiments, the mixing molar ratio range of one or more aliphatic diisocyanate compound, to higher molecular weight polyalkylene oxide compound, to low molecular weight diol chain extender compounds may be 2:1:1, 2:1.7:0.3, or 2:1.5:0.5. In some embodiments, the ratio of higher molecular weight polyalkylene oxide compound to low molecular weight diol chain extender compound is at least 20:30, at least 22:28, at least 25:25, at least 26:24, at least 27:23, at least 28:22, at least 29:21, at least 30:20, at least 31:19, at least 32:18, at least 33:17, at least 34:16, at least 35:15, at least 36:14, at least 37:13, at least 38:12, at least 39:11, at least 40:10, at least 41:9, at least 42:8, at least 43:7, at least 44:6, at least 45:5 or more, with the proviso that the ratio of reactive hydroxy groups provided by the combination of higher molecular weight polyalkylene oxide compounds and low molecular weight diol chain extender compounds to the isocyanate groups provided by the aliphatic diisocyanate compounds is approximately 1:1.

In some further embodiments, the method further comprises the step of isolating the polymer through one or more techniques known to those in the art. In some embodiments, the polymer may be isolated through precipitation in a suitable liquid, which may include aqueous and non-aqueous liquids in which the polyurethane has minimal or no solubility. In other embodiments, the polymer may be isolated by dialysis through use of a dialysis membrane or tubing. The selection of the pore size and resulting molecular weight size cut-off of the dialysis membrane or tubing will be guided by the target molecular weight of the desired polyurethane product. In some embodiments, the molecular weight cut-off may range from 1-100,000 kDa, 2-75,000 kDa, 5-60,000 kDa, 10-10,000 kDa, 15-5,000 kDa, 20-1,000 kDa, or 25-500 kDa. In some embodiments, the dialysis membrane or tubing has a molecular weight cut-off of less than 100,000 kDa, less than 75,000 kDa, less than 50,000 kDa, less than 30,000 kDa, less than 25,000 kDa, less than 20,000 kDa, less than 15,000 kDa, less 10,000 kDa, less than 5,000 kDa, less than 1,000 kDa, less than 750 kDa, less than 500 kDa, less than 300 kDa, less than 200 kDa, less than 100 kDa, less than 75 kDa, less than 50 kDa, less than 40 kDa, less than 30 kDa, less than 25 kDa, less than 20 kDa, less than 15 kDa, less than 10 kDa, less than 5 kDa, or less than 3 kDa. In some embodiments, selection of the molecular weight cut-off is chosen in order to separate unreacted compounds from the polyurethane product. In other embodiments, selection of the molecular weight cut-off is chosen to separate out reaction products having a molecular weight less than a target molecular weight of a desired polyurethane product. Such reaction products thus removed may be submitted to conditions and reagents to further polymerize into larger polyurethane polymers. In some embodiments, multiple rounds of dialysis with dialysis membranes or tubing having differing molecular weight cut-offs may be performed in order to obtain the desired isolated polyurethane product. In some embodiments, the duration of dialysis is not particularly limited and will be selected in order to achieve the desired isolation of the target polyurethane polymer product. In some embodiments, the length of time of dialysis may range from several hours or less to longer than a week.

In some embodiments, the polyurethane polymer may be isolated and purified by lyophilization. The lyophilization may be carried out using well known lyophilization procedures in combination with commercially available lyophilizers to remove excess liquid from the polyurethane product through sublimation thereof. In some embodiments, the lyophilization utilized in combination with one or more other isolation or purification procedures to provide a polyurethane polymer of the desired purity. In certain embodiments, the reaction product is submitted to lyophilization as well as precipitation and/or dialysis. In some embodiments, lyophilization may be conducted after precipitation and/or dialysis.

In some aspects of the invention, it is desirable to limit the amount of water present during the formation of the polyurethane polymer in order to prevent the formation of unstable carbamic acid, urea and/or carbon dioxide and resulting foaming. In some embodiments, the method further comprises the step of removing excess water from one or more of the reagents, including solvents, and starting materials, such as the aliphatic diisocyanate, polyalkylene oxide, diol chain extender, used to form the polyurethane polymers. In some embodiments, removal of excess water may be accomplished through distillation and/or drying of the reagents and starting materials. In some embodiments, excess water is removed from the solid surfaces which come into contact with any of the reagents or starting materials by drying and/or washing said solid surfaces with a silane liquid.

In some embodiments, the one of more steps of providing, mixing or applying one or more conditions is carried out under an inert gas. In still other embodiments, the melting temperature comprises a first melting temperature corresponding to the melting temperature of the soft segment of the thermoplastic polyurethane polymer or a second melting temperature corresponding to the melting temperature of a hard segment of the thermoplastic polyurethane polymer. In some embodiments, the first melting temperature comprises at least 40° C., at least 45° C., at least 50° C., at least 55° C., at least 60° C., at least 65° C., at least 70° C., at least 75° C., but less than 90° C., less than 80° C., less than 75° C., or less than 70° C. In some embodiments, the second melting temperature comprises at least 100° C., at least 105° C., at least 110° C., at least 115° C., at least 120° C., at least 125° C., at least 130° C., at least 140° C., at least 150° C., at least 160° C., or at least 170° C. In some embodiments, the first melting temperature comprises 50-80° C., 50-70° C., 60-70° C., 50-60° C., or 70-80° C. In some embodiments, the second melting temperature comprises 100-130° C., 100-110° C., 105-115° C., 110-120° C., or 120-130° C.

In some aspects of the invention, the polyurethane polymer displays minimal swelling when exposed to water. In some embodiments determination of the swelling of the polyurethane polymer is not specifically limited and may include methods commonly used in the art or any method described herein. In some embodiments, the minimal swelling is determined by comparing wet mass of the polyurethane during water dissolution to the dry mass of the same polyurethane before contact with water, wherein an increase of less than 2.5 times of wet mass over dry mass defines the polyurethane as having minimal swelling during dissolution in water. In some embodiments, the swelling is determined by measuring the maximum difference in volume of a predetermined amount of the polyurethane polymer before and after submersion in water for a period of time. In other embodiments, when the polyurethane polymer is formed into a shape, the difference between the cross-sectional area of the shaped polyurethane polymer before and after submersion in water is used to determine swelling. When the swelling is determined by measuring differences in volume or cross-sectional area, swelling is determined to be minimal when the volume or cross-sectional area increases by less than 50%, less than 40%, less than 30%, less than 25%, less than 20%, less than 15%, less than 12.5%, less than 10%, less than 7.5%, less than 5%, less than 2.5%, less than 1%, or less than 0.5% compared to a dry volume or cross-sectional area. In certain embodiments, the polyurethane polymer demonstrates substantially no swelling in water, which is defined as demonstrating less than 10%, less than 5% or less than 3% increase in volume or cross-sectional area at any time when submerged in water until dissolved.

Some aspects of the present disclosure are directed to a water-soluble, non-toxic, thermoplastic polyurethane composition comprising a polyurethane made by the process that comprises i) providing one or more aliphatic diisocyanate compounds; ii) providing one or more higher molecular weight polyalkylene oxide compounds having a molecular weight of approximately 600-150,000 g/mol; iii) providing one or more low molecular weight aliphatic diol chain extender compounds having a molecular weight of approximately 50-300 g/mol; iv) mixing, sequentially or simultaneously, in molar ratios of 50:49-20:1-30, the one or more aliphatic diisocyanate compounds, the one or more polyalkylene oxide compounds and the one or more low molecular weight aliphatic diol chain extender compounds; wherein the ratio of isocyanate groups provided by the aliphatic diisocyanate compounds to reactive hydroxyl groups provided by the combination of the polyalkylene oxide compounds and diol chain extender compounds is approximately 1:1; and v) applying one or more conditions sufficient to polymerize the one or more aliphatic diisocyanate compounds, the one or more high molecular weight polyalkylene oxide compounds and the one or more low molecular weight aliphatic diol chain extender compounds, either sequentially or simultaneously, thereby synthesizing a water-soluble, non-toxic, thermoplastic polyurethane polymer, wherein the polyurethane has a melting temperature of 50-240° C., has a soft segment content of at least 80%, is dissolvable at room temperature or 37° C. in water having an approximately neutral pH, is non-cytotoxic to human kidney fibroblasts, and displays minimal swelling when exposed to water.

Some aspects of the present disclosure are directed to a polyurethane polymer composition comprising a water soluble, non-toxic, thermoplastic polyurethane polymer which is the reaction product of at least the following: one or more aliphatic diisocyanate compounds; one or more higher molecular weight polyalkylene oxide compounds having a molecular weight of approximately 600-150,000 g/mole; one or more low molecular weight aliphatic diol chain extender compounds having a molecular weight of approximately 50-300 g/mol; and optionally, a catalyst; wherein the one or more aliphatic diisocyanate compounds, the one or more polyalkylene oxide compounds and the one or more low molecular weight aliphatic diol chain extender compounds are reacted in molar ratios of 50:49-20:1-30, wherein the ratio of isocyanate groups provided by the aliphatic diisocyanate compounds to reactive hydroxyl groups provided by the combination of the polyalkylene oxide compounds and diol chain extender compounds is approximately 1:1; and wherein, the thermoplastic polyurethane has a soft segment content of at least 80%, possesses a melting temperature of approximately 50-240° C., is dissolved at room temperature or 37° C. in water having an approximately neutral pH and is non-cytotoxic to human kidney fibroblasts.

In some embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, dicyclohexylmethane diisocyanate, bisisocyanatocyclohexylmethane, 2,2,4-trimethylhexamethylene diisocyanate, disisocyanatomethylcyclohexane, norbornane diisocyanate, diisocyanatododecane or combinations thereof. In other embodiments, the one or more aliphatic diisocyanate compounds are selected from the group consisting of ethylene diisocyanate, propylene diisocyanate, butylene diisocyanate, pentylene diisocyanate, hexamethylene diisocyanate, heptamethylene diisocyanate, octamethylene diisocyanate, nonamethylene diisocyanate, decamethylene diisocyanate, diisocyanatododecane or mixtures thereof. In a particularly preferred embodiment, the one or more aliphatic diisocyanate compounds comprise hexamethylene diisocyanate.

In some embodiments, the one or more polyalkylene oxide compounds comprise a polyethylene oxide, polypropylene oxide or polybutylene oxide polymer. In some embodiments, the one or more polyalkylene oxide compounds comprise a molecular weight of 8,000-100,000 g/mol. In some embodiments, the one or more polyalkylene oxide compounds comprise a molecular weight of 10,000-80,000 g/mol. In other embodiments, the one or more polyalkylene oxide compounds comprise a molecular weight of 12,000-50,000 g/mol. In some embodiments, the one or more polyalkylene oxide compounds comprise a molecular weight of 15,000-30,000 g/mol. In a particularly preferred embodiment, the one or more polyalkylene oxide compounds comprise a molecular weight of approximately 20,000 g/mol.

In some embodiments, the one or more polyalkylene oxide compounds comprise a molecular weight of approximately 60-200 g/mol. In some embodiments, the one or more low molecular weight aliphatic diol chain extender compounds has a molecular weight of approximately 60-150 g/mol. In some embodiments, the one or more low molecular weight aliphatic diol chain extender compound has a molecular weight of approximately 80-125 g/mol.

In other embodiments, the one or more low molecular weight aliphatic diol chain extender compounds are selected from the group consisting of ethylene glycol, diethylene glycol, triethylene glycol, 1,2-propylene glycol, 1,3-propane diol, 1,4-butane diol, 1,6-hexane diol, 1,7-heptane diol, 1,8-octane diol, 1,9-nonane diol, 1,10-decane diol, neopentyl glycol, dipropylene glycol, tripropylene glycol and combinations thereof. In some embodiments, the one or more low molecular weight aliphatic diol chain extender compounds are selected from the group consisting of ethylene glycol, 1,3-propane diol, 1,4-butane diol, 1, 5-pentane diol, 1,6-hexane diol, 1,7-heptane diol, 1,8-octane diol, 1,9-nonane diol, 1,10-decane diol and combinations thereof. In other embodiments, the one or more low molecular weight aliphatic diol chain extender compounds are selected from the group consisting of 1,4-butane diol, 1,6-hexane diol, 1,8-octane diol, 1,10-decane diol and combinations thereof. In a preferred embodiment, the one or more low molecular weight aliphatic diol chain extender compounds comprise 1,4-butane diol.

In a particularly preferred embodiment, the one or more aliphatic diisocyanates comprise butylene diisocyanate, pentylene diisocyanate, and/or hexamethylene diisocyanate, the one or more polyalkylene oxide polymer compounds comprise polyethylene oxide or polypropylene oxide polymers with a molecular weight of 15,000-30,000 g/mol and the one or more low molecular weight aliphatic diol chain extender compounds comprise 1,3-propane diol, 1,4-butane diol, 1,5-pentane diol or 1,6-hexane diol. In another preferred embodiment, the one or more aliphatic diisocynates comprise hexamethylene diisocyanate, the polyalkylene oxide polymer comprises polyethylene oxide having a molecular weight of approximately 20,000 g/mol and the one or more low molecular weight aliphatic diol chain extender compounds comprise 1,4-butane diol.

In some embodiments, the polyurethane polymer has a soft segment content of greater than 84%. In other embodiments, the polyurethane polymer has a soft segment content of greater than 90%. In still other embodiments, the polyurethane polymer has a soft segment content of greater than 97%. In one preferred embodiment, the polyurethane polymer has a soft segment content of greater than 98%.

In some embodiments, the reaction is a result of mixing simultaneously all of the one or more aliphatic diisocyanate compounds, the one or more polyalkylene oxide compounds, the one or more low molecular weight aliphatic diol chain extender compounds, and optionally, one or more of a catalyst, and solvent(s), to provide a first mixture and then exposing the first mixture to one or more conditions selected from the group consisting of heat, a duration of time, or combinations thereof, thereby obtaining the water-soluble, non-toxic, thermoplastic polyurethane polymer.

In some embodiments, one or more aliphatic diisocyanate compounds, the one or more high molecular weight polyalkylene oxide compounds, and optionally, one or more of a catalyst, and solvent(s), and are mixed to form a pre-mixture and subsequently exposed to one or more conditions selected from the group consisting of heat, a duration of time, or combinations thereof, thereby obtaining a urethane prepolymer, prior to reacting to the one or more low molecular weight diol chain extender compounds to obtain the water-soluble, non-toxic, thermoplastic polyurethane polymer.

In some embodiments, the one or more low molecular weight diol chain extender compounds, and optionally, one or more of a catalyst, and solvent(s), are mixed to obtain a second mixture and subsequently exposed to one or more conditions selected from the group consisting of heat, a duration of time, or combinations thereof, to obtain the water-soluble, non-toxic, thermoplastic polyurethane polymer. In still further embodiments, the first mixture, pre-mixture and/or second mixture is exposed to heat greater than 100° C. in the absence of a catalyst. In some embodiments, the first mixture, pre-mixture and/or second mixture is exposed to heat less than 100° C., in the presence of a catalyst, thereby synthesizing the water-soluble, non-toxic thermoplastic polyurethane polymer or urethane prepolymer.

In some embodiments, the first mixture, pre-mixture and/or second mixture is exposed to a temperature of 40° C. to 90° C. In other embodiments, the first mixture, pre-mixture and/or second mixture is exposed to a temperature of approximately 70° C.

In some embodiments, the catalyst is selected from the group consisting of stannous octoate, dibutyltin dilaurate, dibutyltin diacetate, dioctyltin dilaurate, 1,4-diazabicyclo[2.2.2]octane, 2-azabicyclo[2.2.1]heptanes, 2-azanorbornanes, 1,8-Diazabicyclo[5.4.0]undec-7-ene, 1,5,7-Triazabicyclo[4,4,0]dec-5-ene, bis(2-dimethylaminoethyl)ether, N-ethylmorpholine, N-methylmorpholine, N,N′-Dimethylethanolamine, N,N-Dimethylcyclohexylamine, Trimethylamineoethylethanolamine, N,N,N′,N′,N″-Pentamethyldiethylenetriamine, Dimethylaminopropylamine, N,N-Dimethylaminoethylmorpholine, 2-Methyl-2-azanorbornane, 3-hydroxy-1-azabicyclo[2.2.2]octane, tetramethylenediamine, dimethylpiperazineN-heterocyclic carbenes, potassium octoate, potassium acetate, lithium octoate, Bismuth octoate, bismuth neodecanoate, zinc octoate, zinc neodecanoate, zirconium octoate, cobalt octoate, nickel octoate, potassium octoate, calcium octoate, antimony octoate, lanthanum octoate, zirconium acetylacetonate, titanium acetylacetoacetate, aluminum acetylacetoacetate methane sulfonic acid, triflic acid and diphenyl phosphate.

In other embodiments, the solvent comprises dimethyl sulfoxide (DMSO), N,N-dimethylformamide, N,N-dimethylacetamide, or tetrahydrofuran (THF). In some embodiments, the molar ratio range of the one or more aliphatic diisocyanate compounds, to the higher molecular weight polyalkylene oxide compounds, to the low molecular weight diol chain extender compounds is 50:49-25:1-25. In particularly preferred embodiments, the molar ratio range of the one or more aliphatic diisocyanate compounds, to the higher molecular weight polyalkylene oxide compounds, to the low molecular weight diol chain extender compounds is 50:49-40:1-10.

In some embodiments, the polyurethane polymer demonstrates minimal swelling when exposed to water. In some embodiments, the minimal swelling is determined by comparing wet mass of the polyurethane during water dissolution to the dry mass of the same polyurethane before contact with water, wherein an increase of less than 2.5 times of wet mass over dry mass defines the polyurethane as having minimal swelling during dissolution in water.

In some embodiments, the non-toxicity of the polyurethane polymer is determined by incubating human kidney fibroblasts in cell culture medium containing 0.1 mg/mL of the dissolved thermoplastic polyurethane for 24 hours, wherein the thermoplastic polyurethane polymer is determined to be non-toxic if cellular metabolic activity, as measured by a resazurin fluorescence assay, is not decreased at the end of the 24 hour incubation period.

In another aspect of the invention, the polyurethane polymer composition dissolves readily in water. The method for determining the dissolution rate of the polyurethane polymer composition in water is not particularly limited and may include dissolution testing protocols known in the art or any methods described herein. In some embodiments, a polyurethane polymer composition is determined to dissolve readily in water, if a predetermined amount of the polyurethane polymer composition dissolves in water, with or without agitation, if it substantially dissolves within 48 hours, within 36 hours, within 30 hours, within 24 hours, within 20 hours, within 16 hours, within 12 hours, within 10 hours, within 8 hours, within 6 hours, within 5 hours, within 4 hours, within 3 hours, within 2 hours, within 60 minutes, within 45 minutes, within 30 minutes, within 20 minutes, within 15 minutes or within 10 minutes of submersion in water. In some embodiments, the polyurethane polymer composition dissolves readily in water as measured by a 1.75 mm diameter filament formed therefrom substantially dissolving in deionized water at room temperature in approximately 4 hours or less, 3 hours or less, 2 hours or less, 1 hour or less, 30 minutes or less or 15 minutes or less without agitation.

In some embodiments, the polyurethane polymer is linear and is substantially free of crosslinking and/or branching. In other embodiments, the polyurethane polymer is formed substantially with no aromatic isocyanate compounds or isocyanate compounds that have more than 2 isocyanate groups per compound. For purposes of the invention, formed from substantially no aromatic isocyanate compounds and isocyanate compounds that have more than 2 isocyanate groups per compound is defined as utilizing a source of aliphatic diisocyanate that comprises less than 10%, less than 5%, less than 3% or less than 1% of aromatic isocyanate or tri- or higher functional isocyanates by weight. In no circumstance, however, will commercially available sources of high purity aliphatic diisocyanates be deemed to be excluded from the invention if they contain a combination of aromatic isocyanate and tri- or higher functional isocyanates in an amount greater than 10%, but less than 15% by weight.

In some embodiments, the composition further comprises a water-based solvent in an amount of approximately 30 wt % to 80 wt % by weight of the polyurethane polymer composition. In some embodiments, the composition takes the form of a gel. In some embodiments, the polyurethane polymer is present at approximately 20 wt % to 70 wt % by weight of the polyurethane polymer composition. In some embodiments, the polyurethane polymer makes up greater than 70% and up to and including 100% of the polyurethane polymer composition. In preferred embodiments, the composition consists essentially of or consists of the polyurethane polymer.

Some aspect of the present disclosure are directed to a method of making a basement membrane construct, comprising the steps of (a) printing a sacrificial structure comprising the water soluble, non-toxic thermoplastic polyurethane composition as described herein onto a support structure or a thin layer comprising functional basement membrane material with a three dimensional printer thermoplastic printhead, (b) applying a thin layer comprising functional basement membrane material to the sacrificial structure, thereby obtaining one layer of the construct, (c) optionally repeating steps (a) and then (b) one or more times to obtain one or more additional layers of the construct, (d) optionally embedding the product of steps (a) and (b), and optionally (c) in a sacrificial or permanent material, and (e) dissolving the sacrificial material by exposing the sacrificial material to a water-based solvent, to provide one or more interior volumes that retain the original shape and size of the printed sacrificial structure, thereby making a basement membrane construct, wherein the thin layer is porous and has a thickness of 0.25-10 μm.

In some embodiments, the basement membrane construct may comprise multiple layers, each individual layer may optionally comprise interior volumes that connect to form a channel network. In some embodiments, the channel networks of a first and a second layer of the construct are fluidly connected directly or interface through a membrane. This membrane is capable of filtering fluid passing through the membrane from a first channel network of a first layer to a second channel network of a second layer of the construct. In some embodiments, the membrane is a fibrous membrane that has been subjected to one or more post-fabrication treatments selected from compression, annealing, chemical crosslinking, stretching, drawing, heat treatment, and solvent welding, whereby the treated fibrous basement membrane material is imparted enhanced mechanical properties and altered morphological properties compared to a fibrous basement membrane material not receiving one or more of the post-fabrication treatments.

In some embodiments, the thin layer comprising functional basement membrane material is a fibrous membrane material. In some embodiments, the fibrous membrane comprises one or more of gelatin, gelatin composites, collagen, fibrin, chitosan, nitrocellulose, polylactic acid, polycaprolactone, polyethylene glycol, polyethylene glycol diacrylate or other biopolymers, polymers, or decellularized tissue or extra-cellular matrix that has been liquified or homogenized.

In some embodiments, the thin layer comprising basement membrane material comprises electrospun fibers. In some embodiments, the fibrous basement membrane material comprises electrospun fibers comprising a first component selected from the group consisting of polycaprolactone, polyethylene glycol, and polyethylene glycol diacrylate, and a second component selected from the group consisting of gelatin, collagen and fibrin, and wherein the fibrous basement membrane has a thickness of 0.5-30 μm. In some embodiments, the fibrous basement membrane material comprises first materials selected to provide a fibrous basement membrane substrate with strength, while a second material is chosen to provide a substrate capable of being remodeled by cells seeded thereon.

In some embodiments, the thin layer comprising fibrous basement membrane material inhibits or prevents an immunological reaction by a subject to cells and other substances within the basement membrane construct. In some embodiments, the inhibition or prevention of an immunological reaction by a subject is to cells within a luminal space of the construct or within bulk material or tissue into which the thin layer comprising basement membrane material is embedded, encased or by which it is surrounded or covered. In some embodiments, the inhibition or prevention of an immunological reaction by a subject is to substances within a luminal space of the construct or within bulk material or tissue into which the thin layer comprising the basement membrane material is embedded, encased or by which it is surrounded or covered. In some embodiments, the inhibition or prevention of an immunological reaction by a subject is achieved when the basement membrane construct is implanted within the subject, or is used extracorporeally, wherein a luminal space of the construct is in fluid communication with a luminal space of a subject. In some embodiments, the luminal space of a subject with which the construct is in fluid communication is the cardiovasculature, and/or another luminal space within or in fluid communication with the liver, pancreas, kidney, small intestine, large intestine, brain, or spine.

In some embodiments, the fibrous basement membrane material comprises pores of sufficient size to enable diffusion of one or more biologically relevant molecules. The pore size of the pores in the fibrous membrane may be any suitable size and is not limited. In one embodiment, the average or median pore size diameter is about 0.05 to about 0.6 μm. In another embodiment, the average or median pore size diameter is about 0.05 μm, 0.1 μm, 0.15 μm, 0.2 μm, 0.25 μm, 0.3 μm, 0.35 μm, 0.4 μm, 0.45 μm, 0.5 μm, 0.55 μm or about 0.6 μm. The porosity of the nanofiber membrane (Pₙₘ), obtained by dividing volume of voids (Vᵥ) by the total volume of nanofiber membrane measured (V_{Tvm}) (P=Vᵥ/V_{Tvm}*100%), may be any suitable porosity and is not limited. In some embodiments the porosity is at least 5%, 10%, 20%, 30%, 40%, 50%, 60%, 70%, 80%, 90% or more. In other embodiments the porosity is between 20-80%, 30-70% or 40-60%.

In some embodiments, the one or more channels are capable of withstanding at least 60 mmHg internal pressure. In another embodiment, the one or more channels are capable of withstanding an internal pressure of at least 80 mmHg, 100 mmHg, 150 mmHg, 200 mmHg, 250 mmHg, 300 mmHg, 350 mmHg, 400 mmHg, 450 mmHg, 500 mmHg, 550 mmHg, or at least 600 mmHg.

In some embodiments, the vascular channel network is capable of withstanding at least 60 mmHg internal pressure. In another embodiment, the vascular channel network is capable of withstanding an internal pressure of at least 80 mmHg, 100 mmHg, 150 mmHg, 200 mmHg, 250 mmHg, 300 mmHg, 350 mmHg, 400 mmHg, 450 mmHg, 500 mmHg, 550 mmHg, or at least 600 mmHg.

In some embodiments, the fibrous basement membrane material has been subjected to one or more post-fabrication treatments selected from compression, annealing, chemical crosslinking, stretching, drawing, heat treatment, and solvent welding, whereby the treated fibrous basement membrane material is imparted enhanced mechanical properties compared to a fibrous basement membrane material not receiving one or more of the post-fabrication treatments. In some embodiments, the enhanced mechanical properties are selected from the group consisting of enhanced tensile strength, enhanced tensile modulus, enhanced abrasion resistance, enhanced thermal stability, enhanced elongation at break, enhanced hardness, enhanced crystallinity and combinations thereof. In some embodiments, the post-fabrication treatment comprises solvent welding. In some embodiments, the solvent welding is conducted in the presence of pressure imparted by opposing support substrates. In some embodiments, post-fabrication treatment comprises heat treatment in combination with pressure imparted by opposing support substrates.

In some embodiments, the post-fabrication treatment may be carried out between 20-22° C., or at a temperature greater than 22° C. In some embodiments, the post-fabrication step is performed below the glass transition temperature (Tg) of one, two or all of the materials used to form the fibrous membrane, such as at least 5° C., 10° C., 15° C., 20° C., 30° C. or more below the glass transition temperature.

In certain embodiments, the post-fabrication step is annealing performed at a temperature that is approximately equal to the glass transition temperature of the material used to form the fibrous membrane. For purposes of this application, approximately equal to the glass transition temperature (Tg) is defined as a published glass transition temperature of the material ±5° C., or ±5% of the published Tg, whichever provides the smaller temperature range. In some embodiments, the post-fabrication step is conducted at a temperature that falls between the glass transition temperature and the melting temperature of the material used to form the fibrous membrane. It will be appreciated by one of ordinary skill in the art that as the temperature is increased above the glass transition temperature, care should be taken to select an appropriate post-fabrication treatment time to ensure that porosity of the membrane is not destroyed through substantial melting of the fibrous membrane.

In some embodiments, the fibrous membrane is subjected to a post-fabrication step at a temperature of greater than 25° C., 30° C., 35° C., 40° C., 45° C., 50° C., 55° C., 60° C., 65° C., 70° C., 75° C., 80° C., 85° C., 90° C., 100° C., 125° C., 150° C., 160° C., 170° C., 180° C. or more. In some embodiments the post-fabrication step is carried out for a period of time of 1 second, 5 seconds, 10 seconds, 15 seconds, 30 seconds, 45 second, 1 minute, 2 minutes, 3 minutes, 4 minutes, 5 minutes, 6 minutes, 7 minutes, 8 minutes, 9 minutes, 10 minutes, 20 minutes, 30 minutes, 45 minutes, or 1 hour. In certain embodiments it is desired to conduct the post-fabrication treatment for a longer period of time, including a time of 1.5 hours, 2 hours, 3, hours, 4, hours, 5 hours, 6 hours, 7 hours, 8 hours, 9 hours, 10 hours, 15 hours, 16 hours, 17 hours, 18 hours, 19 hours, 20 hours, 25 hours, 1 day, 2 days, 3 days, or more.

In some embodiments the post-fabrication annealing step includes application of compression to facilitate wrapping of a sacrificial substrate with a fibrous membrane, as described herein. In some embodiments, application of compression at elevated temperature facilitates superior or more rapid bonding or annealing of the fibers. In some embodiments the post-fabrication annealing and compression steps are conducted at a temperature between 120-180° C., 40-70° C., 45-65° C., 50-60° C. or 53-57° C., and for a time period of 11-25 hours, 13-22 hours, 15-20 hours, or 17-19 hours. In certain preferred embodiments the compression and annealing steps are conducted for approximately 18 hours at approximately 55° C.

The magnitude of pressure utilized in the compression step is not particularly limited, as long as it is sufficient to facilitate the bonding or annealing of the fibers where they intersect, while protecting the fibrous membrane or substrate to which it is applied from damage. In some embodiments, the compression is applied by placing the fibrous membrane, and substrate upon which it was fabricated, between two opposing releasing substrates of a size, shape and hardness that permits application of sufficient force to induce bonding or welding of the fibers, without damaging the fibrous membrane or substrate to which it is applied. In some embodiments, the releasing substrates are soft silicone pads. In certain preferred embodiments, the compression step is carried out by placing fibrous membrane and sacrificial substrate between two silicon pads resting on a solid surface, wherein the only compression is generated by the weight of the silicon pad placed on top thereof.

In some embodiments, additional compression force may be applied by using a pressure applied by placing increasingly heavier objects on top of the upper silicon pad. In some embodiments, the pressure applied to the fibrous membrane and sacrificial substrate is in the compression treatment is less than 25 psi, less than 20 psi, less than 18 psi, less than 15 psi, less than 12 psi, less than 10 psi, less than 8 psi, less than 7 psi, less than 6 psi, less than 5 psi, less than 4 psi, less than 3 psi, less than 2 psi, less than 1 psi, less than 0.5 psi, less than 0.4 psi, less than 3 psi, less than 2 psi, or less than 0.1 psi. In some preferred embodiments, when the pressure is applied in presence of heat, the pressure is 0.05 psi to 2 psi, 0.05 psi to 1 psi or 0.1 to 0.8 psi. In some further embodiments, the pressure applied during the compression treatment is 0.5-5 psi, 2-8 psi, 5-14 psi, 3-7 psi, or 18-25 psi.

In some embodiments, the post-fabrication treatment comprises exposing the fibrous membrane to a solvent to facilitate welding together of partially softened or swollen fibers at their point of intersection. The solvent used for solvent welding should be capable of at least partially softening or swelling the fibers of the fibrous membrane material to facilitate welding of the fibers together, given a reasonably amount of time. In some embodiments, the solvent is non-toxic. In other embodiments, the solvent has a Hildebrand solubility parameter similar to that of the material used to form the electrospun fibrous membrane. In circumstances where a given concentrated solvent may quickly dissolve and destroy the morphology of the fibers of the fibrous membrane, the solvent may be mixed with one or more non-solvents to provide a diluted solvent formulation that is capable of providing controlled swelling and welding of the fibers together, without destroying the morphology of these fibers. In some embodiments, the solvent is selected from one or more of acetone, methyl ethyl ketone, dimethylacetamide, ethyl acetate, methyl acetate, N-methyl pyrrolidone, propylene carbonate, lactate esters, diethyl ether, dichloromethane, tetrahydrofuran, ethanol and methanol. In some embodiments, the solvent is acetone in concentrated form, such as formulations approaching 100% pure acetone (NEAT). In some embodiments, the acetone is diluted with a polar non-solvent, such as isopropanol, to provide a formulation comprising 20-80% acetone. In certain embodiments, the acetone has been diluted to a concentration of 50% or 25%.

Methods by which the solvent is applied to the fibrous membrane are not particularly limited, so long as the solvent is applied relatively uniformly to at least one side of the fibrous membrane. In some embodiments, the solvent may be applied to the fibrous membrane before the membrane is contacted with the sacrificial substrate. In some embodiments, the fibrous membrane is saturated with acetone. Saturation of the fibrous membrane with solvent may be carried out through soaking, dipping or spraying, in combination with a duration of time that permits saturation. In some embodiments, it is not desirable to saturate the fibrous membrane with a solvent. In these circumstances, the solvent may be applied to a surface of the fibrous membrane in limited amounts, such as by spraying. In some embodiments, 0.5-10 mL of solvent is applied per 100 cm² of fibrous membrane. In some embodiments, 0.5-1.5 mL, 1.0-2.5 mL, 2.0-4.0 mL, 3.0-4.5 mL, 4.0-5.5 mL, 5.0-6.5 mL, 6.0-7.5 mL, 7.0-8.5, or 8.0-9.5 mL of solvent is applied per 100 cm² of fibrous membrane.

In some embodiments, the solvent welding is accompanied by the application of compression to further facilitate induction of morphological change in the fibrous membrane when applied over a sacrificial substrate and/or to enhance the weld between the fibers of the fibrous membrane. The particular pressure utilized in the compression step to facilitate morphological change of the membrane and welding of the fibers together can be any pressure disclosed herein and is not particularly limited, so long as the pressure does not result in collapse of the substrate to which the fibrous membrane is applied. In some embodiments, the compression is utilized in combination with solvent welding, and includes a compression force of at least 0.1-25 newtons, generated by compressing opposite release substrates that sandwich the fibrous membrane and sacrificial substrate to which the fibrous membrane is applied.

In some embodiments, application of compression during a post-fabrication solvent welding step reduces the time required to obtain a strong weld between the fibers. The particular time required to impart a strong weld under compression is not particularly limited and includes duration of times as disclosed herein. In some embodiments, the fibrous membrane is exposed to pressure and/or solvent for at least 30 seconds, 45 seconds, 60 seconds, 75 seconds, 90 seconds, 105 seconds, 120 seconds, 2.5 minutes, 3 minutes, 3.5 minutes, 4 minutes, 4.5 minutes, 5 minutes, 5.5 minutes, 6 minutes, 6.5 minutes, 7 minutes, 7.5 minutes, 8 minutes, 8.5 minutes, 9 minutes, 9.5 minutes, 10 minutes or more.

In some embodiments, the post-fabrication treatment includes physical or chemical cross-linking of the fibers. In some embodiments, the crosslinking is achieved by exposure to ultraviolet light, gamma-radiation or plasma, by inclusion of a one or more crosslinking agents, or combinations thereof. The crosslinking agents that can be used to facilitate crosslinking of the fibers are not particularly limited, but include those which induce the formation of a covalent bond between compounds found in adjacent fibers. In some instances, the crosslinking agents include glyoxal, isocynates, glutaraldehyde, formaldehyde, carbodiimides, epoxides, citric acid, tannin, ferulic acids, glyceraldehyde, genepin or transglutaminase.

In some embodiments the post-fabrication treatment alters the morphology and/or enhances the mechanical properties of the fibrous membrane. The enhanced mechanical properties may include, but are not limited to one or more of enhanced tensile strength, enhanced tensile modulus, enhanced abrasion resistance, enhanced thermal stability, enhanced elongation at break, enhanced hardness, and enhanced crystallinity. Changes in morphology include, but are not limited to, one or more of increase in fiber diameter, decrease in fiber diameter, increase in porosity, decrease in porosity, increase in pore tortuosity, and decrease in pore tortuosity.

In some embodiments, step (b) comprises electrospinning a fibrous thin layer membrane directly onto of the sacrificial structure, followed by subjection to post-production treatment to impart enhanced mechanical properties to the fibrous thin layer membrane. In some embodiments, step (b) comprises application of pre-formed thin layer comprising functional basement membrane to the sacrificial substrate in combination with compression and either heat or solvent, thereby obtaining a sacrificial substrate wrapped with a thin layer comprising functional basement membrane.

In some embodiments, obtaining the one or more layers in step (c) comprises printing a sacrificial structure comprising water soluble, non-toxic thermoplastic polyurethane composition directly upon the thin layer comprising functional basement membrane material applied to the sacrificial structure in the previous step (b). In some embodiments, obtaining the one or more layers in step (c) comprises printing a sacrificial structure comprising a water soluble, non-toxic thermoplastic polyurethane composition on a support substrate or a thin layer comprising functional basement membrane which is not the thin layer applied in the previous step (b), and prior to the embedding of step (d), further combining the one or more additional layers obtained in step (c) with the layer obtained by initially performing steps (a) and (b).

In some embodiments, the one or more layers of the construct obtained in step (c) and the layer obtained by initially performing steps (a) and (b) are individually or together configured into a desired three dimensional shape before step (d).

In some embodiments, the water soluble, non-toxic thermoplastic polyurethane is heated during printing to 100° C. to 250° C. In some embodiments, wherein both a chamber and a bed temperature are held at 25° C. during the three-dimensional printing process.

In some embodiments, wherein the sacrificial structure is printed in a serpentine or bifurcated pattern. In some embodiments, the product of step (a) and (b), and optionally (c) is embedded into or layered with polydimethylsiloxane, methacrylated gelatin, bulk tissue material or other matrix forming material. The bulk tissue material or other matrix forming materials are those non-toxic materials recognized in the field for use in tissue constructs or bioscaffolds to provide structure, and that facilitate growth and integration of cells and tissues therein. Specific examples include, but are not limited to, Type I collagen, fibrin, fibronectin, entactin, elastin, elastin-like polypeptides, gelatin, laminins, such as laminin 511, homogenized or liquified extracellular matrix or decellularized tissue and combinations thereof. In some embodiments, the product of step (a) and (b), and optionally (c) is embedded into a material when the material is in a liquid state. In some embodiments, the process of embedding utilizes a mold with a shape and size selected to facilitate implantation in a desired location within a patient or to permit a desired function of the finished product. In yet other embodiments, the product of step (a) and (b), and optionally (c) are layered with a material that is present within a gelled or solid state.

In some embodiments, the product of step (a) and (b) and optionally (c) is embedded into or layered with a material that has been seeded with or comprises cells. The types of cells and bulk tissue seeded and placed on or within the product of step (a), (b) and/or optionally (c) are not particularly limited and include any of the cells or bulk tissue types recited herein. In a preferred embodiment, the cells include stem cells, endothelial cells, cardiomyocytes, parietal epithelial cells, hepatocytes, biliary cholangiocytes, stellate cells, adipocytes, osteoblasts, osteocytes, osteoclasts, enterocytes, Goblet cells, enteroendocrine cells, Paneth cells, microfold cells, cup cells, tuft cells, or other cells which are present in the kidney, pancreas, lung, heart muscle, liver, spleen, small intestine, large intestine, neural tissue, skeletal muscle, composite tissue, fat tissue, bone tissue, or skin.

Some aspects of the present disclosure are directed to a method of making a microfluidic device, comprising the steps of: a) printing a sacrificial structure comprising the water soluble, non-toxic thermoplastic polyurethane composition described herein on a support structure or a thin film layer with a three dimensional printer thermoplastic printhead; b) embedding the product of step (a), with or without the support structure or thin film layer, in a sacrificial or permanent material; and c) optionally repeating steps (a) and then (b) one or more times; and d) dissolving the sacrificial material by exposing the sacrificial material to a water-based solvent, to provide one or more interior volumes that substantially retain the original shape and size of the printed sacrificial structure, thereby making a microfluidic device.

In some embodiments, the material comprises methacrylated gelatin, polydimethylsiloxane, or other matrix forming material. In other embodiments, the sacrificial structure comprises an extended longitudinal profile, a substantially elliptical or circular cross-sectional profile and wherein the provided one or more interior volumes comprise channels. In some embodiments, the sacrificial structure is formed into a serpentine or bifurcated pattern with a constant or non-constant diameter.

### EXAMPLES

### Methods

### Synthesis of Water-Soluble Polyurethane (WPU)

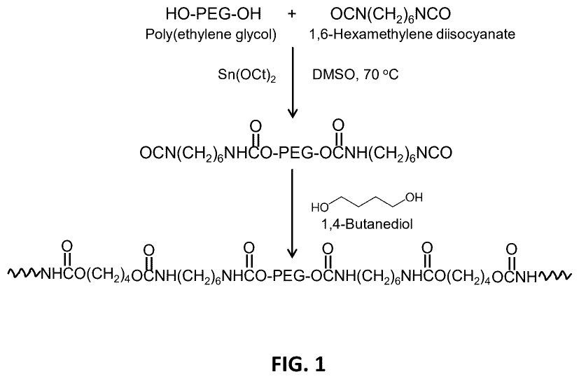

In one embodiment, the WPU polymer was synthesized using poly(ethylene glycol) (PEG; Mw=20,000; Sigma), 1,6-hexamethylene diisocyanate (HDI; Sigma), and 1,4-butanediol (BDO; Sigma) via a two-step process (FIG. 1). PEG was dissolved initially in dimethyl sulfoxide (DMSO; Sigma) at 70° C. in a three-neck flask under N₂ protection. HDI was then added into the flask, followed by the addition of stannous octoate (Sn(Oct)₂; Sigma) catalyst. After 3 hours, the BDO/DMSO solution was then added dropwise to the prepolymer solution in the flask. The final polymer concentration was 4% (w/v). The reaction was carried out for 4 days at 70° C. The polymer was purified via dialysis and lyophilization. The feeding molar ratio of PEG, HDI and BDO varied to confer tunable dissolving capability, which is summarized in Table 1.

TABLE 1
Water-soluble polyurethane formulation

| Materials | PEG:HDI:BDO |
|---|---|
| WPU1 | 37.5:50:12.5 |
| WPU2 | 32.5:50:17.5 |
| WPU3 | 25:50:25 |

### WPU Characterization

The Fourier transform infrared spectrometer (FTIR, Agilent 680) was used to verify polymer chemical structure. The melting temperature (Tm) was determined using a differential scanning calorimeter (DSC, Perkin-Elmer Pyris 1) from −40 to 200° C. at a heating rate of 10° C./min with nitrogen flow.

### 3D Printing of WPU

Polyurethanes were printed on a BIO X™ (Cellink, Sweden) using a BIO X™ Thermoplastic printhead. Polyurethanes were heated to different temperatures from 150° C. to 200° C. Both chamber and bed temperatures were held at 25° C. Different patterns were printed with a nozzle moving speed at 1-5 mm/s and nozzle inner diameter at 400 μm.

### Dissolution in Water

Polyurethanes were molded to cylinder shape specimens at 1.75 mm Diameter; 4.5 mm length and soaked in deionized water (DI water) at room temperature. The dissolution of the specimens was monitored as the function of time. At each predetermined time point, the remaining materials (n=3) were taken out and weighed (W₁), and then dried and weighed (W₂). The wet mass remaining, and dry mass remaining were calculated as follows:

$$Wet mass remaining ( \% ) = {W}_{1} / {W}_{0} \times 100 \%$$

$$Dry mass remaining ( \% ) = {W}_{2} / {W}_{0} \times 100 \%$$

AquaSys® 120 spool was cut into specimens with the same dimensions as the control.

### Swelling Behavior

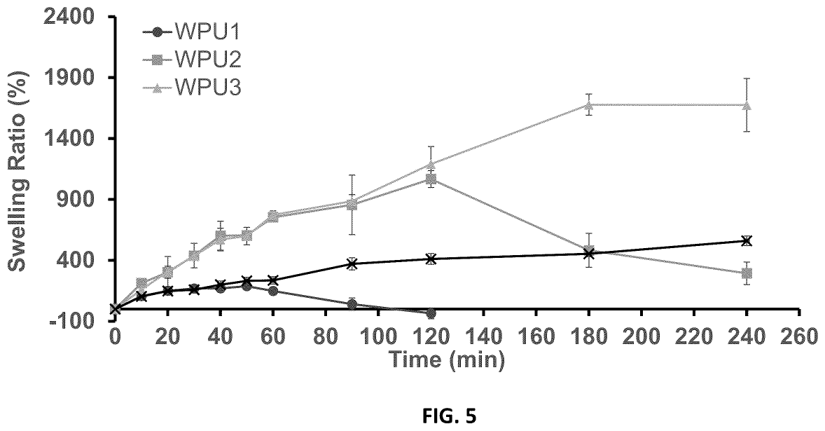

The weighed WPU cylinders (W₀) were immersed in 100 mL deionized water at 25° C. At each predetermined time point, the polyurethane samples (n=3) were taken out, removed the residual water on the surface, and weighed (W₂). The swelling ratio was calculated as (W₂−W₀)/W₀×100%. AquaSys® 120 printed cylinders with the same dimensions as the control group (FIG. 5).

### Cytotoxicity of WPU

Polyurethanes were dissolved in cell culture medium at 0.01 mg/mL, 0.1 mg/mL, and 1 mg/mL, respectively, and then sterilized by 0.22 m membrane filter prior to cell culture study. Human kidney fibroblasts (HKF) were seeded on 12-well cell culture plates with a density of 8×10⁴ cells per well in culture medium. After incubation for 1 day, the polyurethane/water solution with final concentrations at 0.01, 0.1 and 1 mg/mL was added to each well. The cellular metabolic activity (n=4) was measured using a resazurin fluorescence assay after 24 hours of culture.

### Example 1—WPU Embedded in PDMS

WPU1 was printed into a bifurcation pattern (0.4 mm width, 0.8 mm height, 0.8 mm bifurcation spacing) and then was embedded into polydimethylsiloxane (PDMS; Sylgard®184, Dow Corning). The WPU embedded PDMS device was formed after 5 hrs of curing under 55° C. with two holes punched above the two distal ends of the print by a 3 mm biopsy punch for Luer connection. The WPU/PDMS device was then immersed in water bath under sonication for 3.5 hrs, followed by a red dye perfusion to examine its clearance. The AquaSys® 120 pattern at the same dimensions embedded in PDMS was used as control.

### Example 2—WPU Twisting

An eight-furcation pattern (0.4 mm width, 0.4 mm height, 1 mm bifurcation spacing) was printed from WPU2, twisted, and then embedded in PDMS. After 5 hrs of curing under 55° C., the twisted WPU/PDMS construct was immersed in water bath under sonication for 3.5 hrs to clear the WPU, followed by 1 hr of heating in oven to remove entrapped water vapor. A red dye solution was perfused through the twisted channels to verify its clearance.

### Example 3—Spacing

WPU2 was printed into a serpentine pattern with increasing spacing at 1 mm, 1.2 mm, 1.4 mm, 1.6 mm and 1.8 mm. The WPU2 print was then embedded in 12% methacrylated gelatin (GelMA), followed by photo-crosslinking under near-visible light (wavelength at 395 nm) for 5 min. The WPU/GelMA device was then soaked in PBS and left at 37° C. for 30 min to reach a full WPU clearance. The red dye perfusion was carried out to examine the channel clearance. The WPU/GelMA device was cross-sectioned, and the channel dimension and spacings were measured under microscope. The AquaSys® 120 pattern at the same dimensions embedded in 12% GelMA was used as control.

### Results and Discussion

### WPU Characterization

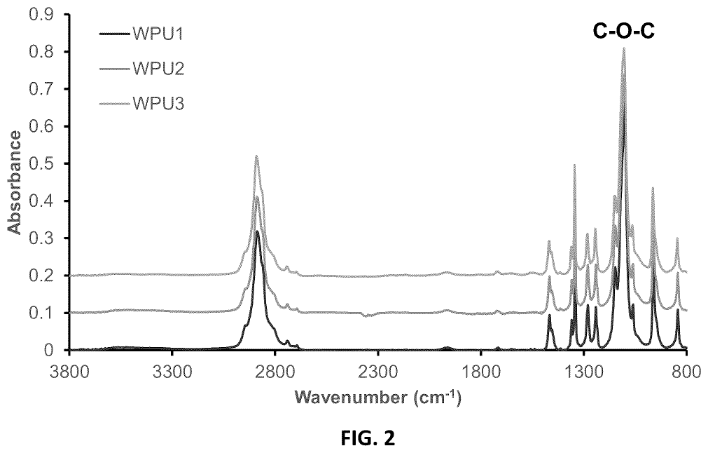

In the FTIR spectra (FIG. 2), the peak at 1101 cm⁻¹ was mainly assigned to the ether groups in the PEG soft segment and also corresponded to the C—O—C stretching absorptions from urethane groups. As the high content of the PEG segment, the intensities of the characteristic peaks from the urethane groups, such as the C═O stretching at 1728 cm⁻¹ and the N—H stretching at 3300-3500 cm⁻¹, become weak.

All water-soluble polyurethanes had two melting temperatures (Tms) as summarized in Table 2. The low Tms resulted from the semi-crystalline PEG soft segment ranging from 62° C. to 65° C. The high Tms were attributed to the hard segments in the polyurethane backbone from 105° C. to 111° C.

TABLE 2
Water-soluble polyurethane melting temperatures

| Materials | Tm₁ (° C.) | Tm₂ (° C.) |
|---|---|---|
| WPU1 | 65 | 105 |
| WPU2 | 63 | 111 |
| WPU3 | 62 | 111 |

### Water Dissolution

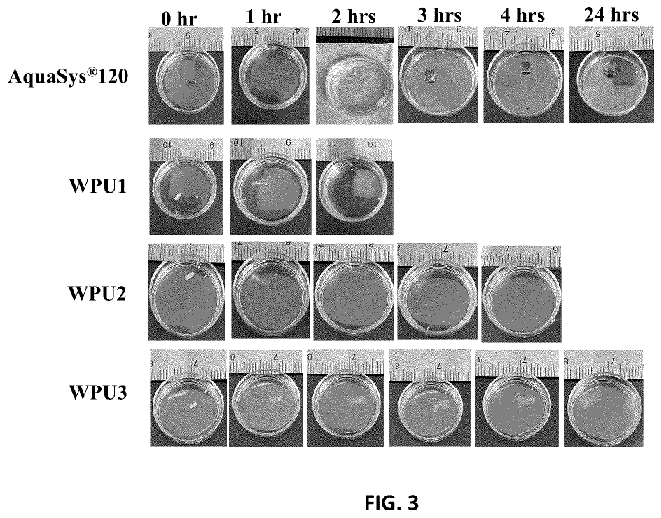

The water dissolving behavior of the water-soluble polyurethanes was recorded in FIG. 3 as a function of time. As shown in FIG. 3, the dimensions of the WPU1 and WPU2 were visibly reduced remarkably. The WPU1 specimen completely disappeared after 2 hrs of dissolution and the WPU2 specimen was basically invisible in water after 4 hrs of dissolution. In contrast, the AquaSys® 120 specimen swelled obviously and remained 14±6% of its initial dry weight after 24 hrs of dissolution. The WPU3 specimen was also in a swollen state and remained 28±4% of its initial dry weight after 24 hrs of dissolution. It is believed that both WPU1 and WPU2 exhibit faster water dissolution than the AquaSys® 120, while the WPU3 has the lowest water dissolution among the four groups.

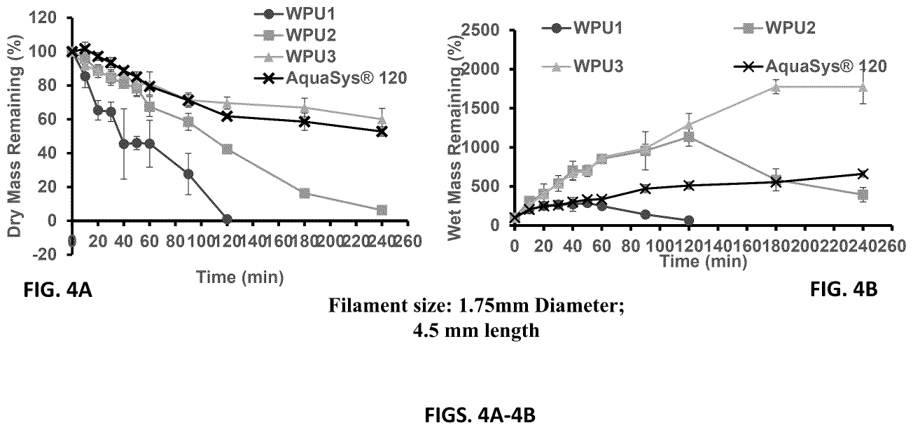

To further quantify the remaining samples, both dry and wet weight measurements were carried out and plotted in FIGS. 4A-B. In dry mass remaining (FIG. 4A, left), the WPU1 was completely dissolved in 120 min of soaking in DI water. The WPU2 retained only 6±3% of dry mass at 240 min. Both WPU3 and AquaSys® 120 retained dry mass at 60±6% and 53±3% at 240 min, respectively. The wet mass remaining (FIG. 4B, right) was a joint result from the polymer dissolving and swelling. Both of WPU1 and WPU2 exhibited a wet weight rise in the beginning, followed by remarkable weight reduction. In particular, the WPU1 had 0 wet mass remaining at 120 min indicating it possessed the fastest water dissolution among the 3 WPU groups. The initial weight rise is a result of partial polymer dissolution which endows the polymer network with a larger amount of water absorption. The following weight reduction is caused by the high degree of polymer dissolution in water, which breaks the polymer network and results in polyurethane disappearance. In contrast, both WPU3 and AquaSys® 120 showed only an increasing trend of the wet mass remaining within 240 min without a decreasing trend, implying their relatively low degree of water dissolution (both retained a dry weight over 50% after 240 min of water dissolution) compared to WPU1 and WPU2.

### Swelling Behavior

The swelling ratios of the water-soluble polyurethanes as a function of time were plotted in FIG. 5. Both WPU1 and WPU2 showed an increasing trend in the beginning with peak swelling ratios at 188±15% and 1067±69% after 50 min and 120 min of water dissolution, respectively. Then the swelling ratios of these two groups dropped dramatically to −36±43% and 293±92% at 120 min and 240 min, respectively. As was stated above, the increasing trend of the swelling ratio is attributed to partially polymer dissolving and the decreasing trend suggests a large number of polyurethanes have been dissolved, thus can no longer retain water. The swelling ratios of the WPU3 and AquaSys® 120 increased to 1675±218% and 560±40%, respectively, in 240 min of water immersion. The lack of decrease in swelling ratio within 240 min indicates the slow water dissolution of the WPU3 and AquaSys® 120.

The swelling performance of the water-soluble polyurethanes is crucial for their use as sacrificial materials, especially when they are embedded into soft materials to create hollow structures. If the soft materials are not strong enough to resist the swelling of the sacrificial materials, then the resolution or even the shape integrity of the hollow structure will be harmed. Both WPU1 and WPU2 showed fast water dissolution (full dissolution within 2 and 4 hrs in DI water at room temperature) and limited swelling make them outstanding candidates as water-soluble sacrificial polymers to create sophisticated overhanging or undercutting structures.

### WPU Cytotoxicity

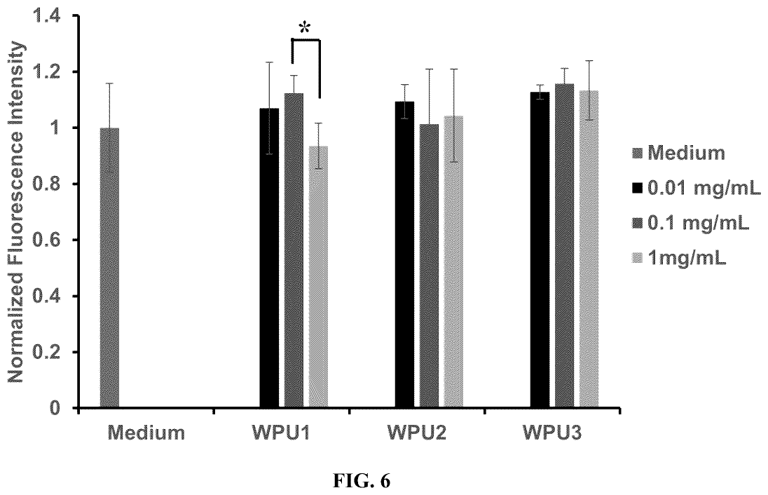

The human kidney fibroblasts were used to evaluate the WPU cytotoxicity. As shown in FIG. 6, the cell viabilities in cell culture medium containing 0.01, 0.1 and 1 mg/mL WPUs showed no significant difference from that of the medium control (p>0.05). The significant difference only existed within the WPU1 group between the 0.1 mg/mL and 1 mg/mL (p<0.05), which might be attributed to the high amount of PEG segments. The result supports that the water-soluble polyurethanes have no obvious cytotoxicity, suggesting their great potential to be used in biomedical applications.

### Example 1—WPU Embedded in PDMS

PDMS is a commonly used material to fabricate microfluidic devices with channels for fluid or air/gas perfusion. One of its defining features includes its highly waterproof property. A common practice for creating channels inside PDMS is creating channels on the surface of a PDMS block and then bonding it to another PDMS block, which risks the generation of a leak at the bonding site. By creating channels inside a monolithic PDMS block, the risk of a potential leakage is effectively prevented along while also achieving a less tedious fabrication process.

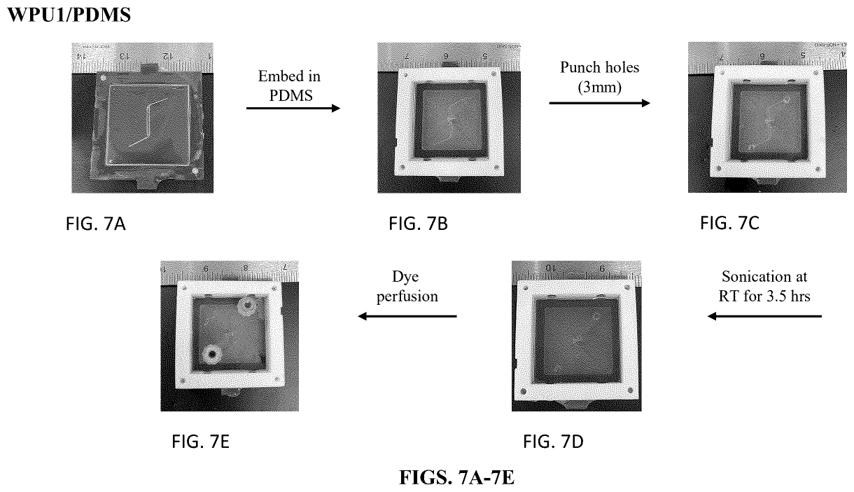

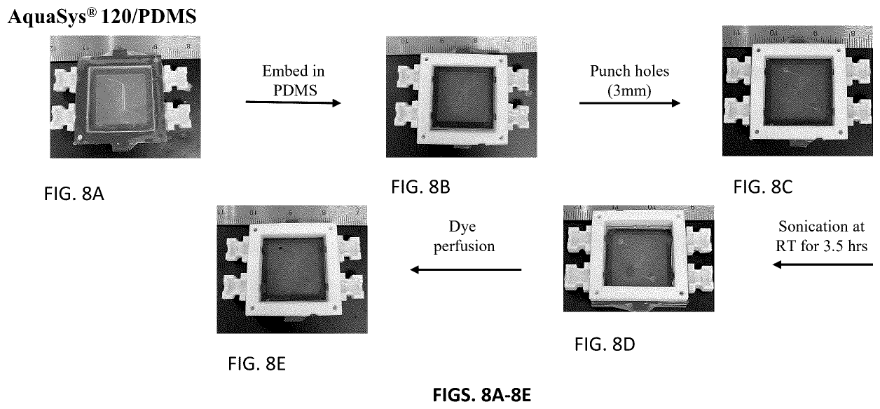

In Example 1 (FIGS. 7A-E), the WPU1 bifurcation print was embedded in PDMS and reached a full clearance under water sonication for around 3.5 hrs. In contrast, the AquaSys® 120 (FIGS. 8A-E) with the same dimension was barely dissolved under the same clearance conditions as the WPU1, which was further confirmed by the red dye perfusion. This example demonstrates an application scenario of the WPU1 which is creating channels inside one piece of PDMS as microfluidic devices.

### Example 2—WPU Twisting

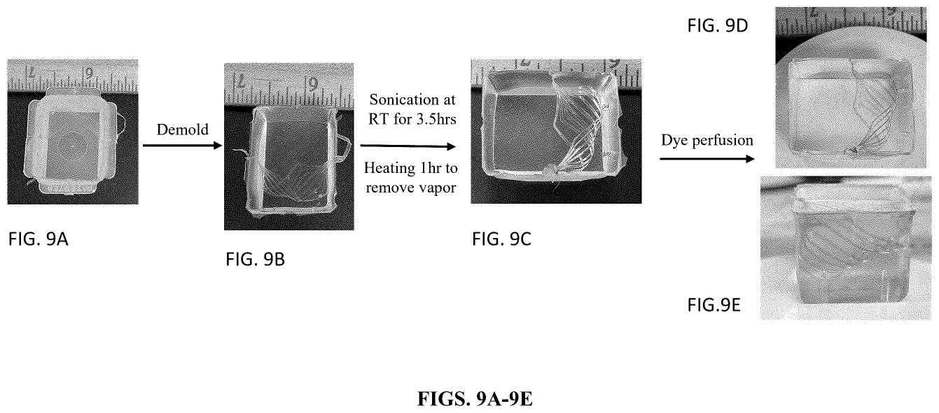

Example 2 is to demonstrate the good flexibility of WPU2 as well as its good water solubility by embedding and clearing an eight-furcation WPU2 pattern into PDMS (FIGS. 9A-E). A complete clearance of the WPU2 print was achieved by 3.5 hrs sonication in water bath and then confirmed by a red dye perfusion.

### Example 3—Spacing

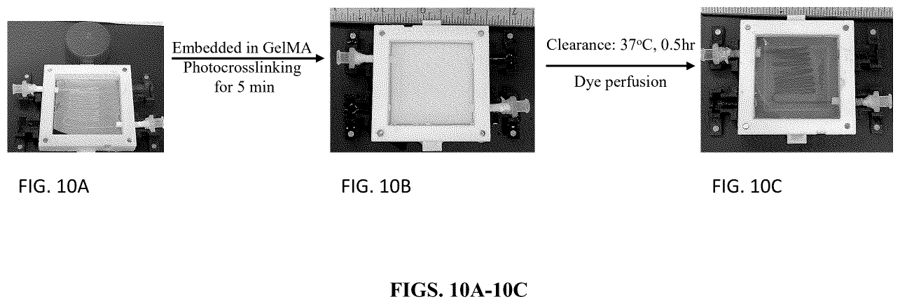

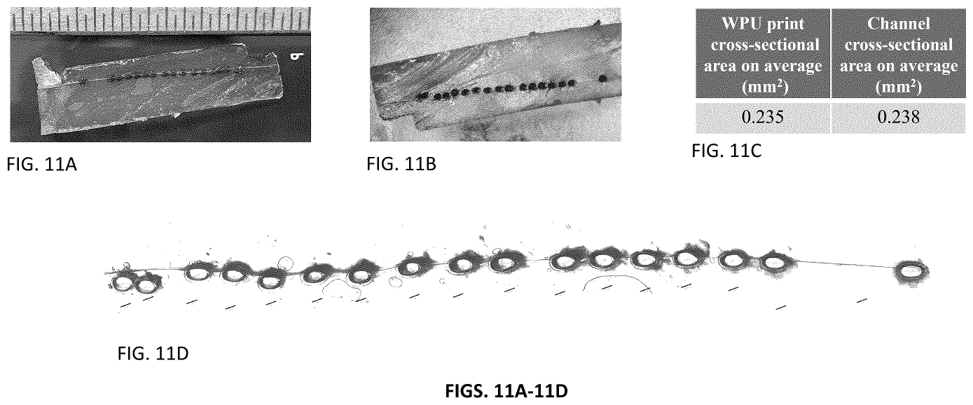

In example 3, a bio-microfluidic device was manufactured by using GelMA as the bulk hydrogel and the WPU2 to create channels (FIGS. 10A-C). The WPU2 was printed into a serpentine pattern with increasing filament spacing from 1 mm to 1.8 mm. By leaving the device in PBS at 37° C. for 30 min, the WPU2 was fully cleared. The cross-sectional images showed that all channels maintained relatively round shape without channel merge (FIGS. 11A-D). Channels can basically maintain its shape fidelity with slight cross-sectional surface area increase (˜1.3%, increased from 0.235 to 0.238 mm²) compared to the original WPU2 print.

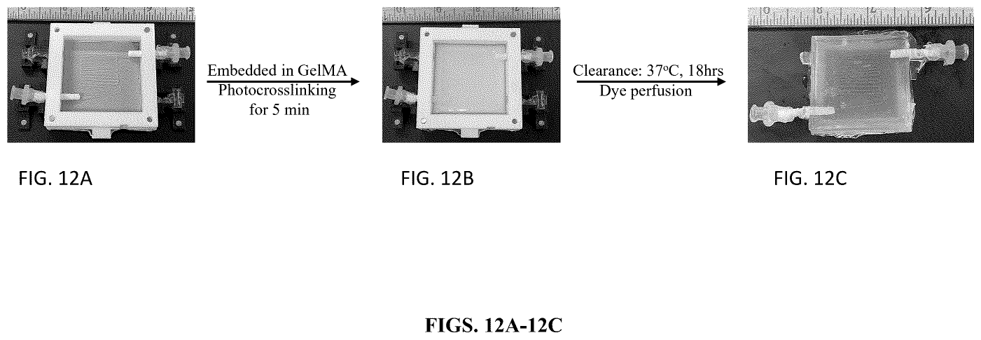

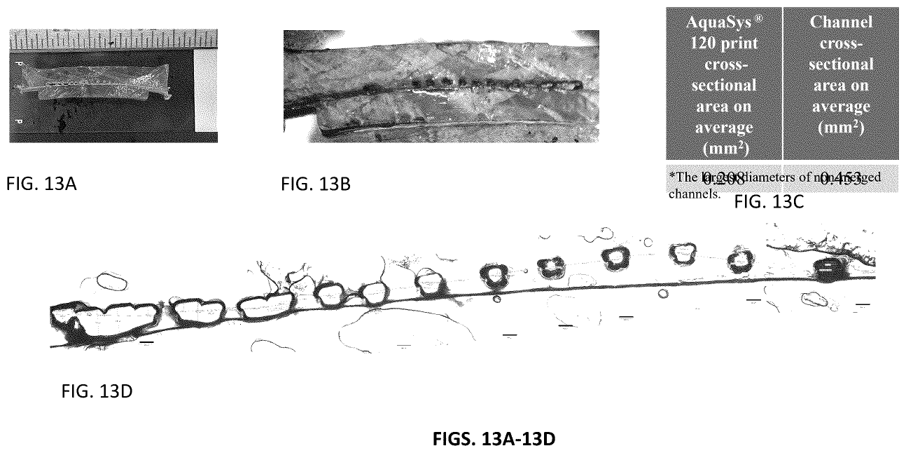

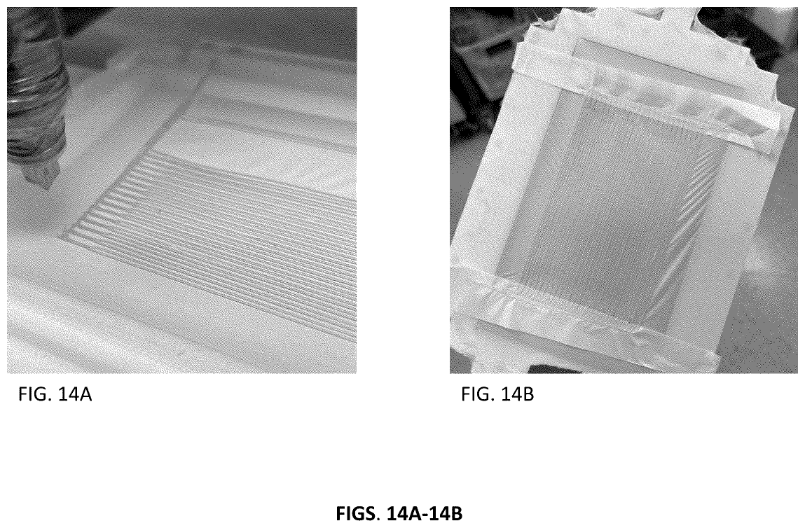

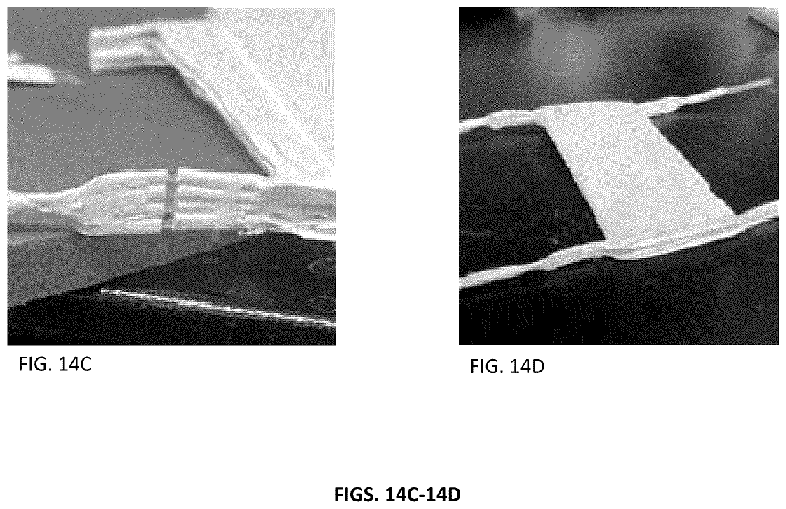

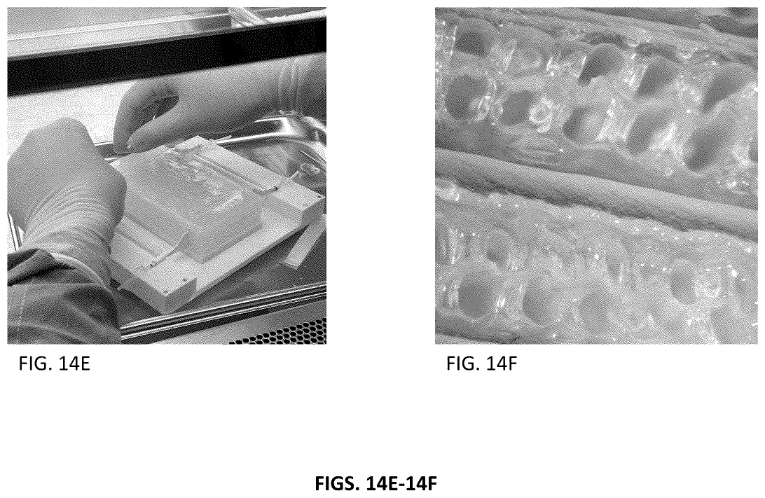

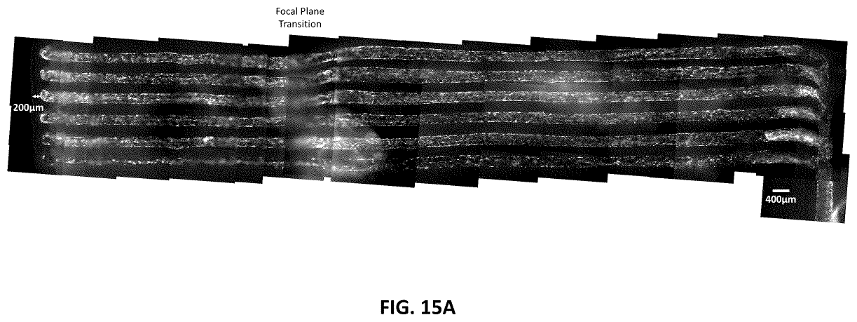

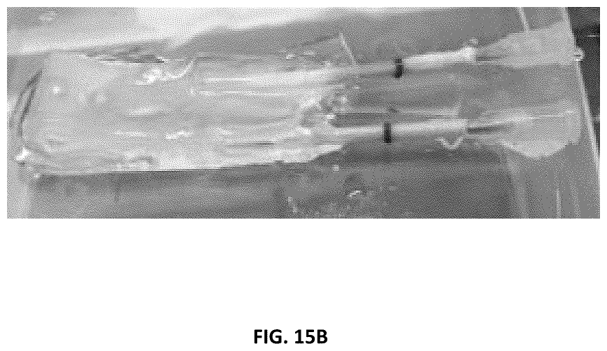

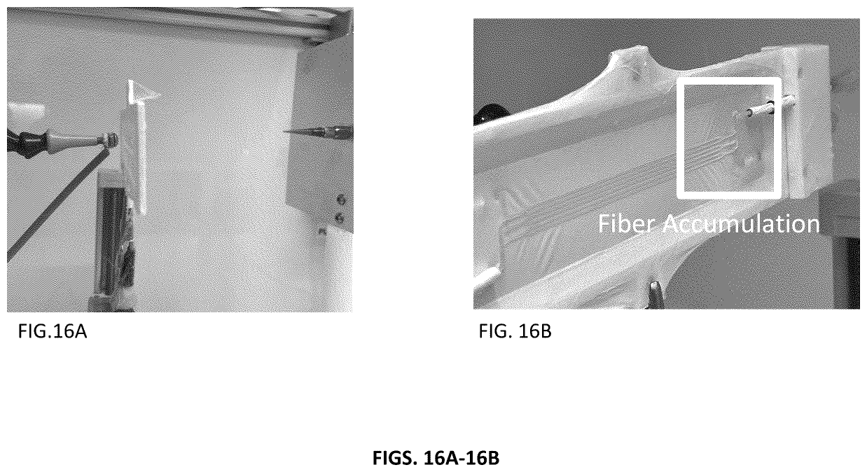

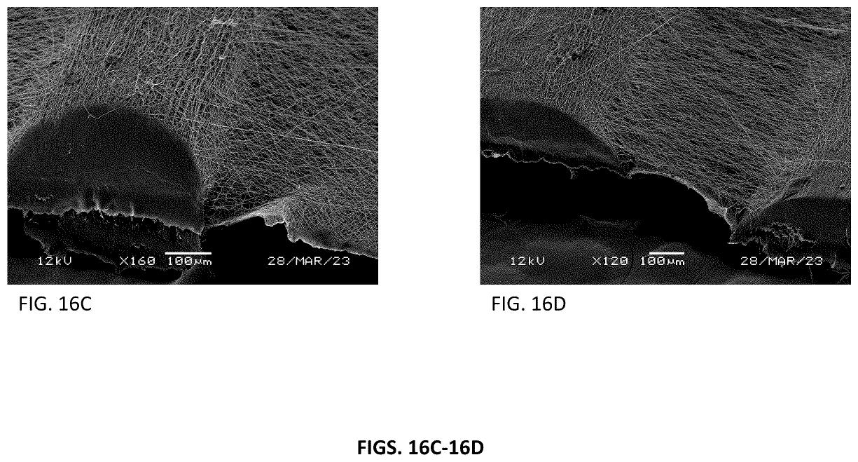

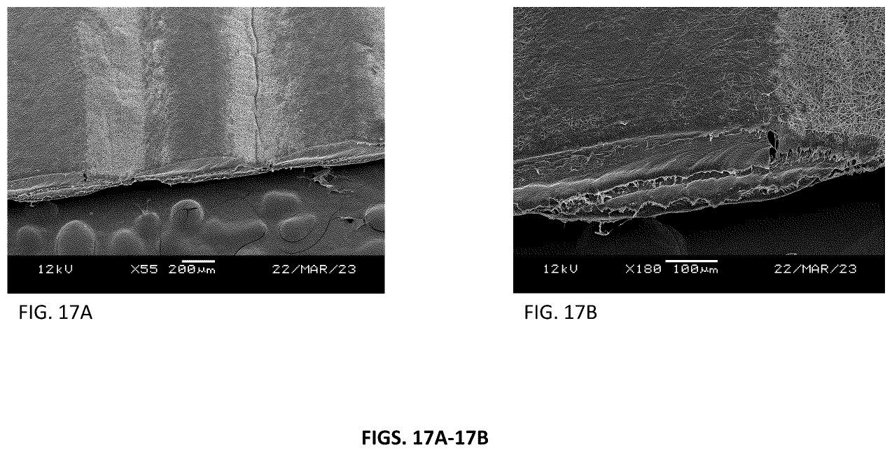

The AquaSys® 120 in the same pattern was used as a control (FIGS. 12A-C), which needed a significant longer time (˜18 hrs) to be cleared under the same conditions as the WPU2. The dye perfusion and cross-sectional images both showed part of the channels merged together due to the slow water dissolution and high water absorption of the AquaSys® 120 (FIGS. 13A-D). In addition, the channels presented an irregular shape other than a round shape after clearance and the channel cross-sectional area increased ˜118% compared to that of its original print.

Example 3 provides another application scenario of the WPU which is creating channels in soft hydrogels with good shape maintenance as bio-microfluidic devices.

1-107. (canceled)

108. A method of synthesizing a water-soluble, non-toxic, thermoplastic polyurethane polymer comprising the steps of:
i) providing one or more aliphatic diisocyanate compounds;
ii) providing one or more higher molecular weight polyalkylene oxide compounds having a molecular weight of approximately 600-150,000 g/mol;
iii) providing one or more low molecular weight aliphatic diol chain extender compounds having a molecular weight of approximately 50-300 g/mol;
iv) mixing, sequentially or simultaneously, in molar ratios of 50:49-20:1-30, the one or more aliphatic diisocyanate compounds, the one or more polyalkylene oxide compounds and the one or more low molecular weight aliphatic diol chain extender compounds; wherein the ratio of isocyanate groups provided by the aliphatic diisocyanate compounds to reactive hydroxyl groups provided by the combination of the polyalkylene oxide compounds and diol chain extender compounds is approximately 1:1; and
v) applying one or more conditions sufficient to polymerize the one or more aliphatic diisocyanate compounds, the one or more high molecular weight polyalkylene oxide compounds and the one or more low molecular weight aliphatic diol chain extender compounds, either sequentially or simultaneously, thereby synthesizing a water-soluble, non-toxic, thermoplastic polyurethane polymer which has a melting temperature of 50-240° C., is dissolved at room temperature or 37° C. in water having an approximately neutral pH, has a soft segment content of at least 80%, and is non-cytotoxic to human kidney fibroblasts.

109. The method of synthesizing a water-soluble, thermoplastic polyurethane polymer of claim 108, wherein the one or more low molecular weight aliphatic diol chain extender compounds has a molecular weight of approximately 60-200 g/mol.

110. The method of synthesizing a water-soluble, thermoplastic polyurethane polymer of claim 108, wherein the one or more polyalkylene oxide polymer compounds comprise a molecular weight of 12,000-50,000 g/mol.

111. The method of synthesizing a water-soluble, thermoplastic polyurethane polymer of claim 108, wherein step iv) comprises simultaneous mixing of all of the one or more aliphatic diisocyanate compounds, the one or more polyalkylene oxide compounds and the one or more low molecular weight aliphatic diol chain extender compounds to provide a first mixture, and wherein step v) comprises exposing the first mixture to one or more conditions selected from the group consisting of heat, a duration of time, a catalyst or combinations thereof, thereby obtaining the water-soluble, non-toxic, thermoplastic polyurethane polymer.

112. The method of synthesizing a water-soluble, thermoplastic polyurethane polymer of claim 108, wherein applying one or more conditions sufficient to polymerize of step v) comprises exposing the first mixture to heat >100° C., in the absence of a catalyst, thereby synthesizing the water-soluble, thermoplastic polyurethane polymer, or exposing the first mixture to heat <100° C., in the presence of a catalyst, thereby synthesizing the water-soluble, thermoplastic polyurethane polymer, while minimizing both formation of allophanate groups and cross-linking of the polyurethane polymer.

113. The method of synthesizing a water-soluble, thermoplastic polyurethane polymer of claim 108, wherein step iv) comprises sequential mixing, and wherein the one or more aliphatic diisocyanate compounds and the one or more high molecular weight polyalkylene oxide compounds are mixed to form a pre-mixture, and wherein step v) of applying one or more conditions sufficient to polymerize comprises exposing the pre-mixture to one or more conditions selected from the group consisting of heat, a duration of time, a catalyst or combinations thereof, thereby obtaining a urethane prepolymer.

114. The method of synthesizing a water-soluble, thermoplastic polyurethane polymer of claim 113, wherein step v) of applying one or more conditions sufficient to polymerize comprises exposing the pre-mixture to heat >100° C., in the absence of a catalyst, or exposing the pre-mixture to heat <100° C., in the presence of a catalyst, thereby synthesizing the urethane prepolymer.

115. The method of synthesizing a water soluble, thermoplastic polyurethane polymer of claim 113, wherein the sequential mixing comprises providing the one or more aliphatic diisocyanate compounds and the one or more high molecular weight polyalkylene oxide compounds in the form of the urethane prepolymer, and mixing the urethane prepolymer with the one or more low molecular weight diol chain extender compounds to obtain a second mixture, and further applying one or more conditions sufficient to form carbamate linkages between the prepolymer and diol chain extender compounds, thereby obtaining the water-soluble, thermoplastic polyurethane.

116. A water-soluble, non-toxic, thermoplastic polyurethane composition comprising a polyurethane made by the process of claim 108, wherein the polyurethane composition has a melting temperature of 50-240° C., has a soft segment content of at least 80%, is dissolvable at room temperature or 37° C. in water having an approximately neutral pH, is non-cytotoxic to human kidney fibroblasts, and displays minimal swelling when exposed to water.

117. A polyurethane polymer composition comprising a water soluble, non-toxic, thermoplastic polyurethane polymer which is the reaction product of at least the following:
one or more aliphatic diisocyanate compounds;
one or more higher molecular weight polyalkylene oxide compounds having a molecular weight of approximately 600-150,000 g/mole;
one or more low molecular weight aliphatic diol chain extender compounds having a molecular weight of approximately 50-300 g/mol; and
optionally, a catalyst;
wherein the one or more aliphatic diisocyanate compounds, the one or more polyalkylene oxide compounds and the one or more low molecular weight aliphatic diol chain extender compounds are reacted in molar ratios of 50:49-20:1-30, wherein the ratio of isocyanate groups provided by the aliphatic diisocyanate compounds to reactive hydroxyl groups provided by the combination of the polyalkylene oxide compounds and diol chain extender compounds is approximately 1:1; and
wherein, the thermoplastic polyurethane has a soft segment content of at least 80%, possesses a melting temperature of approximately 50-240° C., is dissolved at room temperature or 37° C. in water having an approximately neutral pH and is non-cytotoxic to human kidney fibroblasts.

118. The polyurethane polymer composition of claim 117, wherein the one or more polyalkylene oxide compounds comprise a molecular weight of 12,000-50,000 g/mol.

119. The polyurethane polymer composition of claim 117, wherein the one or more low molecular weight aliphatic diol chain extender compounds has a molecular weight of approximately 60-150 g/mol.

120. The polyurethane polymer composition of claim 117, wherein the polyurethane polymer has a soft segment content of greater than 90%.

121. The polyurethane polymer composition of claim 117, wherein the polyurethane polymer composition dissolves readily in water as measured by a 1.75 mm diameter filament formed therefrom substantially dissolving in deionized water at room temperature in approximately 4 hours or less, without agitation.

122. The polyurethane polymer composition of claim 117, wherein the polyurethane polymer is linear and is substantially free of crosslinking and/or branching.

123. The polyurethane polymer composition of claim 117, wherein the polyurethane polymer is formed from substantially no aromatic isocyanate compounds or isocyanate compounds that have more than 2 isocyanate groups per compound.

124. The polyurethane polymer composition of claim 117, wherein the composition further comprises a water-based solvent in an amount of approximately 30 wt % to 80 wt % by weight of the polyurethane polymer composition.

125. The polyurethane polymer composition of claim 124, wherein the composition takes the form of a gel.

126. A method of making a basement membrane construct, comprising:
a. printing a sacrificial structure comprising the water soluble, non-toxic thermoplastic polyurethane composition of claim 117 onto a support structure or a thin layer comprising functional basement membrane material with a three-dimensional printer thermoplastic printhead;
b. applying a thin layer comprising functional basement membrane material to the sacrificial structure, thereby obtaining one layer of the construct;
c. optionally repeating steps (a) and then (b) one or more times to obtain one or more additional layers of the construct;
d. optionally embedding or layering the product of steps (a) and (b), and optionally (c) in or with a sacrificial or permanent material; and
e. dissolving the sacrificial material by exposing the sacrificial material to a water-based solvent, to provide one or more interior volumes that retain the original shape and size of the printed sacrificial structure, thereby making a basement membrane construct, wherein the thin layer is porous and has a thickness of 0.25-10 μm.

127. A method of making a microfluidic device, comprising the steps of:
a. printing a sacrificial structure comprising the water soluble, non-toxic thermoplastic polyurethane composition of claim 117 on a support structure or a thin layer with a three-dimensional printer thermoplastic printhead;
b. embedding or layering the product of step (a), with or without the support structure or thin layer, in or with a sacrificial or permanent material; and
c. optionally repeating steps (a) and then (b) one or more times; and
d. dissolving the sacrificial material by exposing the sacrificial material to a water-based solvent, to provide one or more interior volumes that substantially retain the original shape and size of the printed sacrificial structure, thereby making a microfluidic device.
